(19) United States
(12) Patent Application Publication
(10) Pub. No.: US 2018/0232650 A1
(43) Pub. Date: Aug. 16, 2018

(54) SYSTEMS AND METHODS FOR SPARSE TRAVEL TIME ESTIMATION

(71) Applicant: NEW YORK UNIVERSITY, New York, NY (US)

(72) Inventors: Deepthi Mary DILIP, Abu Dhabi (AE); Nikolaos M. FRERIS, Abu Dhabi (AE); Saif Eddin JABARI, Abu Dhabi (AE)

(21) Appl. No.: 15/893,524

(22) Filed: Feb. 9, 2018

Related U.S. Application Data
(60) Provisional application No. 62/457,692, filed on Feb. 10, 2017.

(51) Int. Cl. G06N 7/00; G06F 17/18; G06N 99/00

(52) U.S. Cl. CPC G06N 7/005; G06N 99/005; G06F 17/18

(57) ABSTRACT

Systems and methods for travel time density estimation based on sparse approximation. The density estimation problem is reformulated as a kernel-based regression problem and sparsity is the driving principle underlying model selection. This is particularly useful when the objective is to promote the predictive capabilities of the model and avoid overfitting; in the context of travel time density estimation, the objective is to determine the optimal number of kernels that can faithfully capture the multiple modes resulting from the state of traffic in the network.

### CROSS-REFERENCE TO RELATED PATENT APPLICATIONS

This application claims priority from Provisional Application U.S. Application 62/457,692, filed Feb. 10, 2017, incorporated herein by reference in its entirety.

### TECHNICAL FIELD

The present disclosure relates generally to systems and methods for sparse travel time estimation.

### BACKGROUND

Travel times are among the prime measures of traffic and travel performance in congested road networks. They can vary dramatically from one location to another and by time of day. This variability, when taken into account by travelers, can have a significant role to play when deciding which route to choose. It is also a key factor in assessing the resilience and reliability of network road segments. The first step in quantifying variability involves the accurate estimation of travel time probability distributions. In signalized urban network settings, variability in travel times can be traced to uncertainty about network supplies and demands (Du et al., 2012), the effect of traffic signals, and the characteristics of route choice (Ramezani and Geroliminis, 2012). In addition, the interrupted nature of traffic contributes significantly to the variability in urban travel times and is the underlying factor contributing to the variability in urban travel times and the multi-modality of their distributions (Hunter et al., 2013b).

Travel time distributions have been extensively studied; along expressways, travel time distributions are typically well captured by unimodal functions such as the lognormal distribution (Richardson and Taylor, 1978; Rakha et al., 2006; Pu, 2011; Arezoumandi, 2011), the Gamma distribution (Polus, 1979) and the Weibull distribution (Al-Deek and Emam, 2006). However, in urban settings with traffic signals, multi-modality tends to be the case (Guo et al., 2010). Along high-speed arterials, travel times are well represented by bi-modal distributions: one mode for vehicles that arrive during a green wave and another for those that encounter a red signal. In congested networks with spillover dynamics, one tends to observe more than two modes (Hofleitner et al., 2012b; Yang et al., 2014; Rakha et al., 2011).

To account for the multi-modal nature of observed travel time distributions, researchers have commonly resorted to the use of Gaussian mixtures (Guo et al., 2010; Feng et al., 2014). To accommodate asymmetrically distributed travel times, most commonly observed in congested traffic, skewed component distributions, e.g., the Gamma and lognormal distributions have also been adopted (Kazagli and Koutsopoulos, 2013). Ji and Zhang (2013) developed a hierarchical Bayesian mixture travel time model to model the interrupted nature of traffic flow in urban roads. The Expectation-Maximization (EM) algorithm (Redner and Walker, 1984) and Bayesian techniques constitute the most widely used approaches for estimation. The Bayesian approach, which applies Markov chain Monte Carlo (MCMC) procedures to find appropriate parameter values, is known to be computationally demanding (Chen et al., 2014). As a result, most of the existing works utilize the EM algorithm, which implies Gaussian mixtures. The main shortcoming stems from the symmetry of the Gaussian densities; when the underlying distributions are skewed (as is typically the case with travel times), a large number of mixture components is needed for accurate estimates when using Gaussian (more generally, symmetric) mixture densities. Another disadvantage that comes with assuming Gaussian mixture components is that the resulting probability distributions have non-negative travel times in their supports (i.e., one cannot preclude positive probabilities of negative travel times).

A major limitation of traditional mixture modeling is that it requires a priori knowledge of the number of mixture components. Since the number of components is usually unknown in real-world problems, the problem of determining the right number while simultaneously estimating the associated model parameters may be quite challenging. In situations where the number of components perfectly reflects the number of clusters in the data, nonparametric methods have been proposed as an alternative for selecting the number of clusters. In the case of travel times, these clusters reflect the vehicle groups that encounter similar stop-and-go conditions, which can vary with location, from day-to-day, and with time of day, as a result of varying traffic demands. The problem of determining the optimal number of components has been addressed by researchers in various fields through sparse kernel density estimators using various techniques including support vector machines (Mukherjee and Vapnik, 1999), penalized histogram difference criterion (Lin et al., 2013), and orthogonal forward regression (Chen et al., 2004, 2008).

In real-time settings, in order to capture the changing nature of travel time distributions, it is crucial to devise recursive data processing techniques. An important feature of a recursive technique is the ability to learn and vary the model parameters (including the number of modes) fast and efficiently, capturing changes in traffic conditions in accordance with conditions on the ground. Hofleitner et al. (2012a) fuse streaming GPS probe data with model parameters learned from historical data using the EM algorithm. To tackle the issue of large amounts of data, the EM algorithm was run offline with the model parameters updated periodically, for instance every week or every month. Wan et al. (2013), on the other hand, adopted an online EM algorithm. Notwithstanding, these two methods fail to capture within-day variation as a side-effect of using all the data that is available. While the use of a time window in conjunction with the online EM algorithm (Hunter et al., 2013a) may tackle this problem, the issue of predefining the number of components still remains. Since the number of components can change with every recursive estimation, the ability to automatically infer the number of mixture components from the streaming data becomes critical.

Thus, while numerous approaches have been tried for travel time estimates, there remains a need for an improved method and system. Specifically, there are at least two shortcomings in present travel time distribution estimation methods, which specifically apply to the case of congested stop-and-go traffic. The first shortcoming is related to the determination of the number of modes, which can change from one location in a traffic network to another, as well as by time of day. The second shortcoming is the wide-spread use of mixtures of Gaussian probability densities, which can assign positive probabilities to negative travel times and offer too little flexibility because of their symmetric shape.

### SUMMARY

Embodiments described herein relate generally to systems and methods for estimation of the probability density function of travel time data, for example using a sparse kernel density estimation.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a flowchart illustrating the high-level overview of the methodology.

FIGS. 2A-2B are graphs of True PDF vs. PW PDF vs. sparse kernel PDF. FIG. 2A sparse density with Gaussian mixture component densities, FIG. 2B sparse density with M-L mixture component densities.

FIGS. 3A-D illustrate on embodiment applied to experimental data for Travel time densities of Peachtree Street (southbound, noon) depicting the locations of the travel time samples (green circles along the horizontal axis); 3A is a graph showing M-L mixture densities vs. Parzen density; FIG. 3B is a graph showing Gaussian mixture with two modes vs. Parzen density; FIG. 3C is a graph showing Gaussian mixture with four modes vs. Parzen density; FIG. 3D is a graph showing Gaussian mixture with six modes vs. Parzen density.

FIG. 4: Fitting accuracy of Sparse Density Estimator vs EM for variable number of components; dataset: I-80.

FIG. 5A: Parzen density for training data, hold-out data, and fitted sparse density, FIG. 5B: Fitting error on hold-out data: M-L sparse density estimator (straight line in black) vs EM algorithm for variable number of mixture components (blue); dataset: I-80.

FIG. 6A: Weight vector θ using l₂-regularization and FIG. 6B: Weight vector θ using sparse density estimation (l₁-regularization); dataset: Peachtree (northbound, noon).

FIG. 7: Sparse density estimation, I-80.

FIG. 8A: Weight vector θ for M-L mixture densities and FIG. 8B: Weight vector θ for Gamma mixture densities; dataset: Peachtree (northbound, noon).

FIGS. 9A-9B: Travel time densities of Peachtree Street (northbound, noon): FIG. 9A Gamma mixture, FIG. 9B M-L mixture.

FIG. 10: Time varying travel time density on I-80 (eastbound, PM).

FIG. 11: Recursive estimation of travel time densities: a snapshot of density evolution in real-time; dataset: I-80.

FIG. 12 is a flowchart illustrating the generation of a histogram in accordance with one embodiment.

FIG. 13 illustrates one embodiment to discretize the travel times.

FIG. 14 illustrates one embodiment of a sparse density estimation.

FIG. 15 illustrates Mittag-Lefler kernel determination.

FIG. 16A illustrates compression; FIG. 16B illustrates decompression.

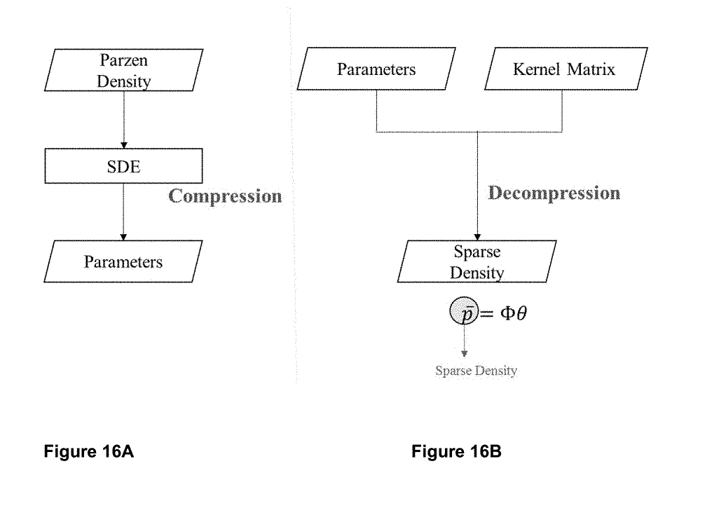

FIG. 17 illustrates one embodiment for streaming spare density estimation.

FIG. 18 illustrates a mixture of Gamma mixture densities where the Gamma probability function is centered at t and evaluated at times {tₘ}ₘ₌₁⁵ with weights {θₘ}_{m=1̂}^{â}.

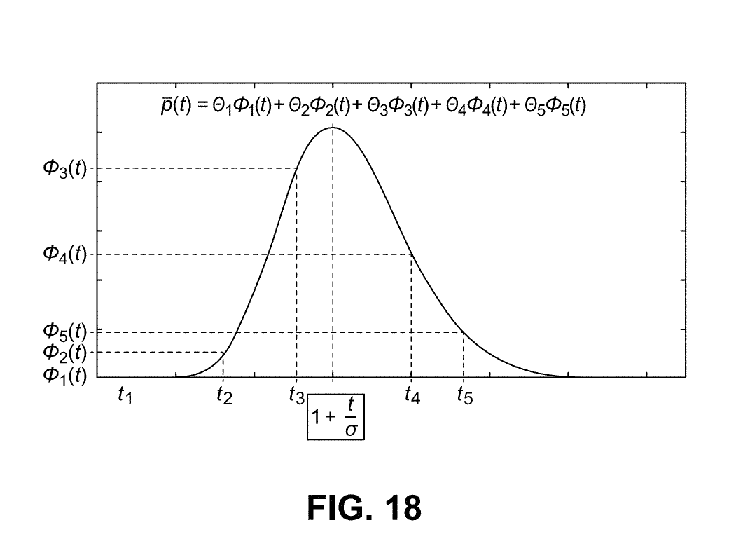

FIG. 19 illustrates a computer system for use with certain implementations.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally to an extension of the sparse density estimator that can sample the data stream recursively, via overlapping windowing, and update the density estimates in real time. With a recursive solver, the memory requirement for the storage of huge amounts of data is minimized. Most importantly, the use of accelerated algorithms to recursively update the density renders our method highly suitable to tackle voluminous real-time data in faster time-scales.

The methods and systems described herein overcome the issues mentioned above pertaining to Gaussian mixtures by, in one embodiment, replacing the Gaussian mixture densities with Gamma densities, which have positive support and can be asymmetric (i.e., they are more flexible). To further enhance parsimony, a richer set of component densities (with variable location and scale parameters) are devised that can be combined to capture a wide variety of travel time distributions. This is achieved by generalizing the Gamma densities using Mittag-Leffler functions. This results in the need to choose those mixture components that most closely capture the empirical distributions. To promote parsimony (i.e., fit with as few mixture components as possible), one embodiment uses an l-regularizer, which is known to promote sparsity. Demonstrated herein is how to apply this methodology on streaming data by (i) updating the inputs whenever a new travel time sample or batch of travel times arrives and (ii) warm-starting the numerical optimization; this allows for a very fast update of the fitted distribution and renders the proposed approach amenable to an online implementation capable of capturing within-day variation of travel times.

The use of Gamma densities (and Mittag-Leffler densities) as mixture components coupled with regularization (to promote parsimony) presents specific analytical challenges. First, to avoid boundary bias², one applies a reversal of the roles of parameter and argument (Chen, 2000). The resulting mixture densities generally do not integrate to unity. This is typically addressed by re-scaling the resulting density. However, the presence of a regularizer renders such re-scaling problematic; it can have a substantial impact on the goodness-of-fit. The proposed solution utilizes a discretization of the component densities and an off-line processing step, which does not affect the applicability of our proposed methods in real-time. The discretization has the advantage of rendering contemporary travel time reliability metrics easy to calculate using our mixture model.

Some embodiments described herein address the two identified shortcomings in present travel time distribution estimation methods namely: the first relating to the determination of the number of modes and the second being the wide-spread use of mixtures of Gaussian probability densities. To address these failings in the current approaches to travel time estimation, some embodiments herein use a sparse kernel density estimation (KDE) technique using asymmetric kernels. Sparse estimation is applied to avoid the need for a predefined number of mixture components. The use of asymmetric Gamma kernels ensures nonnegative supports while also providing increased flexibility in the shapes of the distributions. We also present an adaptive approach to infer both the location and the scale parameters of the kernels and we derive a generalization of the Gamma kernels using Mittag-Leffler functions. To accommodate within-day variability of travel time distributions and also allow for real-time application of the proposed methodology (i.e., fast computation), a recursive algorithm is presented, which updates the fitted distribution whenever new data become available (streaming travel time data). Experimental results using high-dimensional simulated and real-world travel time data illustrate the efficacy of the proposed method, and further demonstrate the generalized Gamma kernels indeed outperform the classical Gaussian kernels in terms of both estimation accuracy and parsimony.

Kernel (or Parzen) density estimation is a nonparametric technique for density estimation which makes no assumptions about the distribution of the data, using a known kernel (similarity function) to smooth out the contribution of each observed data sample over its immediate neighborhood. The sparse kernel density estimator exploits the fact the multi-modal travel time density has a sparse representation when expressed in the proper basis. For instance, consider the case with a bi-modal travel time distribution with two distinct peaks, representing two clusters of vehicles in the traffic stream. Rather than expressing the density as a linear combination of kernels located at every data point with a Parzen estimator, the same density should ideally be captured by two kernels with appropriately chosen location (or time) and scale parameters. The sparse kernel density estimation (KDE) seeks to identify the sparsest set of such basis kernels, from all plausible kernels of varying location/scale parameters. The sparse estimation problem is cast as a convex optimization problem, widely known as the Least Absolute Shrinkage and Selection Operator (LASSO). Restricting our attention to discretized travel times, the ‘sensing matrix’ is constructed by evaluating the basis kernels at points in the discrete sample space. Thus, while the discretization along the rows of the sensing matrix can be viewed as the discretized analog of the continuous travel time data, the column discretization corresponds to the samples at which the probability density is evaluated. The advantages of adopting generalized Gamma kernels, i.e. the Mittag-Leffler kernels, are twofold: a) they ensure nonnegative travel times unlike in the case with the commonly used Gaussian kernels, and b) they offer a framework to vary both the location and the scale parameters of the kernels while ensuring the probability density integrates to one. The sparse KDE can be extended to online estimation of the travel time density, by recursively updating the Parzen estimator and using fast optimization algorithms to tackle the sparse estimation problem, as and when new data becomes available.

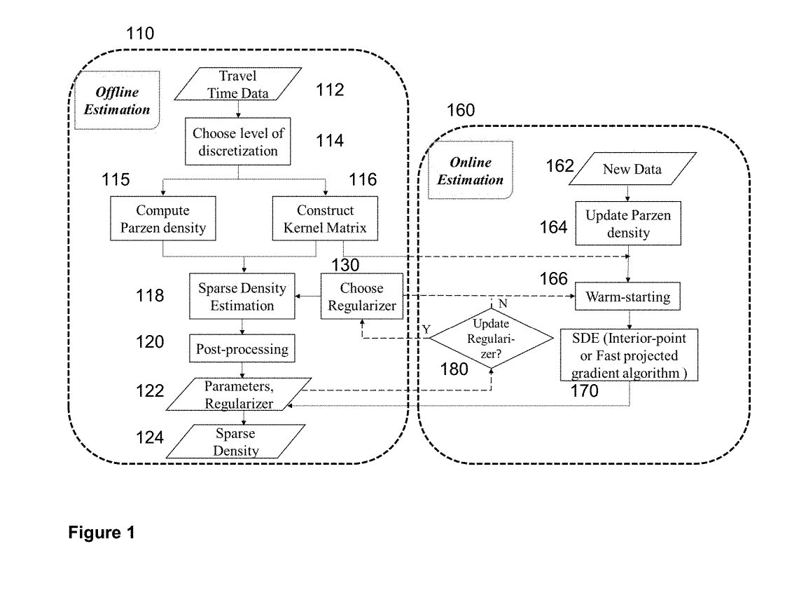

FIG. 1 shows one embodiment of a method for improved travel time distribution estimates. An offline estimation 110 and an online estimation 160 may be utilized. In the offline estimation 110, initial time travel data is received 112. The level of discretization is selected 114. Then Parzen density is calculated 115 and the kernel matrix constructed 116. The construction of the kernel matrix 115 may then directed the method into the online estimation 1160 providing the computed Parzen density to a warm-starting 166. The method may also proceed from the construction of the kernel matrix 116 and computation of the Parzen density 115 to a sparse density estimation 118, which then may follow to post-processing 122 and application of regulation parameters 122. The regularization may be updated by proceeding to the online estimation 160, which if not updated can proceed to the warm-starting 166 or if updated, proceed back to the offline estimation 110 for selection of a regularizer 130 and reestimation of the sparse density 118. The online estimation 160 may include the receipt of new data 162 and the updating of Parzen density 164, proceeding to warm starting 166 and applying a stochastic differential equation (SDE) 170. Following SDE, the method may move to the offline estimation where the regularizer is applied. The result of the method is determination of sparse density 124.

Described herein are some embodiments taking a multi-step approach to improving travel time distribution estimates. First, the problem of kernel density estimation (KDE) is addressed. Next, density estimation is described by using the sparse modeling approach. Having laid that framework, methods are described to develop the generalized Gamma kernels, to present adaptive parameters and address the offline estimation problem. Certain embodiments are then described with regard to the use of the recursive solution technique. Specific embodiments are described in the final section of this specification both simulated data and real-world datasets.

2. The Density Estimation Problem

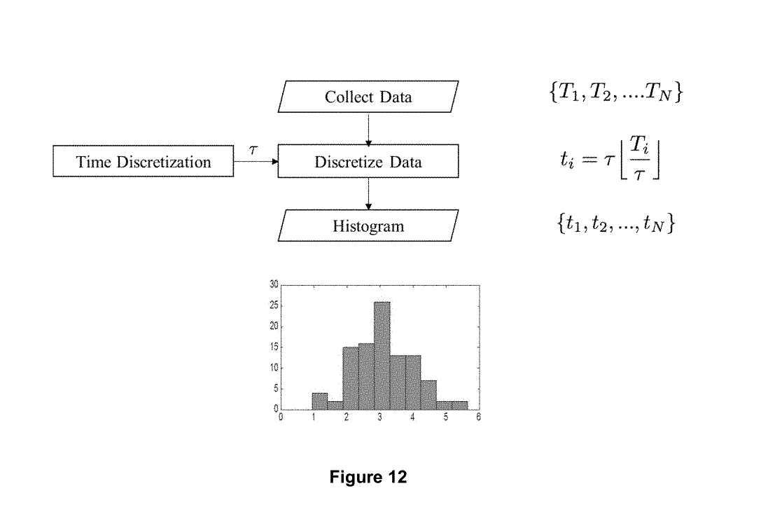

It is important to understand the density estimate problem that arises. For example, N samples t₁,Λ, t_{N} are drawn from a population with probability density function p(⋅). FIG. 12 shows a flow charge of one histrogram generated from discretized data following data collection and time discretization. Specifically, for one embodiment the Parzen density estimate (Parzen, 1962; Cacoullos, 1966; Raudys, 1991; Silverman, 1986) is used and, at t, is given by:

$$\hat{p} ( t ) = \frac{1}{N} {\sum }_{i = 1}^{N} {κ}_{h} ( t - {t}_{i} ) , \qquad ( 1 )$$

where κₕ(⋅) is a window (or kernel) of width h, where h is called the smoothing parameter. The kernel method can also be interpreted as a convolution operation on the data points. For instance, consider the data points t₁,Λ, t_{N}. A histogram of this sample is a discrete probability density function given by:

$$h ( t ) = \frac{1}{N} {\sum }_{i = 1}^{N} δ ( t - {t}_{i} ) , \qquad ( 2 )$$

where δ(⋅) is the Dirac delta measure

$$δ ( t ) = \{ \begin{matrix}1 , & if t = 0 , \\ 0 , & otherwise .\end{matrix} \qquad ( 3 )$$

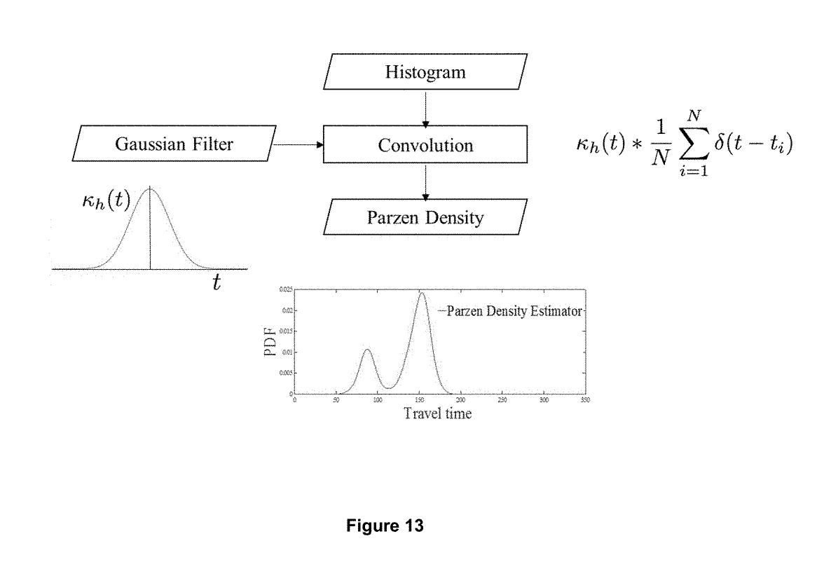

As a preprocessing step, the histogram can be smoothed by filtering, such as by convolution with a low-pass filter or a Gaussian pulse. FIG. 13 shows a flowchart illustrating one embodiment of such discretization. When convolving with a kernel κₕ(⋅), we obtain:

$$\hat{p} ( t ) = {κ}_{h} ( t ) * \frac{1}{N} {\sum }_{i = 1}^{N} δ ( t - {t}_{i} ) = {\int }_{R}^{ } {κ}_{h} ( x ) \frac{1}{N} {\sum }_{i = 1}^{N} δ ( t - x - {t}_{i} ) dt = \frac{1}{N} {\sum }_{i = 1}^{N} {κ}_{h} ( t - {t}_{i} ) . \qquad ( 4 )$$

In order for \hat{p}(⋅) \hat{p}(t) to be a probability density, ∫_{R} \hat{p}(t)dt=1 [symbol] \hat{p}(t)dt=1 ∫\hat{p}(t)dt=1 \hat{p}(t)=1 is required to hold. From (4), for any sample t₁,Λ, t_{N}, we have that this is honored as long as ∫_{R}κₕ(t)dt=1 [symbol] κₕ(t)dt=1 ∫\hat{p}(t)dt=1. This is easy to satisfy for any kernel since we can simply normalize it. In one embodiment, it is required that the kernel is a member of L₁(R) L₁( [symbol] ) L₁( [symbol] ), i.e., ∫_{R}|κₕ(t)|dt<∞ [symbol] |κₕ(t)|dt<∞. More concretely, we will implicitly assume that κₕ(t)≥0 for all t∈ and there exists a constant C<∞ such that ∫_{R}|κₕ(t)|dt=C [symbol] |κₕ(t)|dt=C.

The form of the kernel function is not the sole factor affecting the performance of the estimator: the kernel bandwidth or the smoothing factor h is a crucial tuning parameter for the Parzen density estimate, as even a small change in h can result in a considerably varied representation of the density. Several methods have been proposed to determine this smoothing factor: based either on minimizing the integral mean square error or based on cross-validation techniques (see (Lacour et al., 2016) and references therein for a contemporary treatment of the bandwidth selection problem).

Parzen window (PW) estimators can be regarded as a special type of finite mixture models, where the mixture components are of equal weight and are placed on the training data. The PW estimator requires as many kernels as the number of training samples. As a result, they are prone to overfitting, and may additionally result in substantial storage requirements. PW estimators serve as empirical distribution functions (or generalized histograms), and the goal is to develop models with lesser stored parameters and higher prediction accuracy, while achieving a close fit of the PW densities.

3. Sparse Density Estimation

3.1 Sparse Kernel Density Estimation

] Consider the kernel density

$$\overline{p} ( t ) = {\sum }_{j = 0}^{M - 1} {θ}_{j} {φ}_{j} ( t ) , \qquad ( 5 )$$

where {ϕⱼ(⋅)} are the kernel functions (M in total) and {θⱼ}ⱼ are the kernel weights. We may also assume that ϕ₀(t)=c>0, for all t so that θ₀ (allowed to be zero) serves as an additive constant. For integrability, we need to consider finite support, i.e., [0, T] and

$${φ}_{0} ( t ) ≡ \frac{1}{T} . \qquad ( 6 )$$

Our aim is to achieve a sparse representation of p̅(⋅), i.e., one with most of the elements of the vector θ=[θ₀Λ θ_{M-1}]^{T} being zero while maintaining test performance or generalization capability to that of the PW estimate obtained with an optimized bandwidth h. Also, M is assumed to e large enough that Equation 5 can be fit to a broad class of distributions.

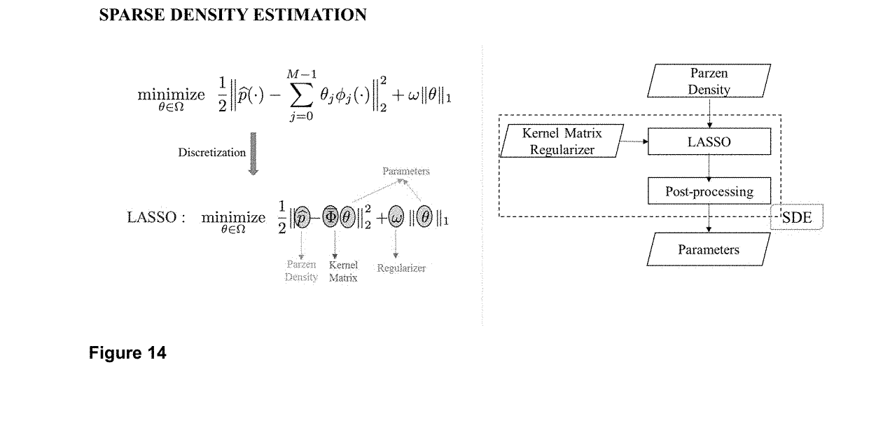

We thus seek to solve:

$${minimize}_{θ ∈ Ω} \frac{1}{2} {‖ \hat{p} ( \cdot ) - {\sum }_{j = 0}^{M - 1} {θ}_{j} {φ}_{j} ( \cdot ) ‖}_{2}^{2} + ω {‖ θ ‖}_{1} , \qquad ( 6 )$$

where Ω⊆ [symbol] ₊^{M} is a set of M-dimensional vectors that we consider for the optimization problem. FIG. 14 shows a process for solving equation 6 to provide sparse density estimation. The L₂ norm is over a suitably chosen functional space and the L₁ norm is the usual vector L₁ norm, also denoted by λ₁. Typically,

$$\frac{1}{2} {‖ p ( \cdot ) - {\sum }_{j = 0}^{M - 1} {θ}_{j} {φ}_{j} ( \cdot ) ‖}_{2}^{2} = \frac{1}{2} \text{?} {( p ( \cdot ) - {\sum }_{j = 0}^{M - 1} {θ}_{j} {φ}_{j} ( \text{?} ) )}^{2} \text{?}$$

$$\text{?} \text{indicates text missing or illegible when filed}$$

It should be noted that solving (equation 6) with Ω=R₊^{M} Ω= [symbol] ₊^{M} Ω= [symbol] ₋^{M} does not guarantee that the resulting fitted distribution p̅(⋅) is a probability density. This is typically achieved by normalizing the result, i.e., by re-scaling: θᵢ←θᵢ/∥θ∥₁ θᵢ←θᵢ∥θ∥₁θᵢ←θᵢ/∥θ∥₁←θᵢ/∥θ∥₁. Nonetheless, there are cases—in a sparse estimation context—where normalization “fails” in the sense that post-normalization fitting error ∥\hat{p}(⋅)−Σⱼ₌₀^{M-1}θⱼϕⱼ(⋅)∥₂²∥\hat{p}(⋅)−Σⱼ₌₀^{M-1}θⱼϕⱼ(⋅)∥₂²∥\hat{p}(⋅)−Σⱼ₌₀^{M-1}θⱼϕⱼ(⋅)∥₂² may not be sufficiently small. This issue is discussed further below. Further, the first term in equation 6, ∥\hat{p}(⋅)−Σⱼ₌₀^{M-1}θⱼϕⱼ(⋅)∥₂², is a measure of goodness-of-fit, the (squared) L₂-distance between the empirical distribiton of data and the fitted distribution. The second term in Equation 6 is a L1 regulizer that promotes sparsity in the vector weights, i.e. a parsimonious solution.

Also, note that (equation 5) has a nice statistical interpretation in light of the following facts: (i)

∥ϕⱼ(⋅∥_{L(R)}=1∥ϕⱼ(⋅)∥_{L}_{₁}⁽ [symbol] ⁾=1∥ϕⱼ(⋅)∥_{L}_{₁}₍ [symbol] ₎=1 and (ii) ∥θ∥₁=1; p̅(⋅) is the posterior density if a kernel ϕⱼ(⋅) is the density with (prior) probability equal to θⱼ.

3.2. Discretizing the Support

To simplify the estimation problem (equation 6), we discretize the travel times. This is done by defining disjoint intervals (uniformly or non uniformly) in the support of the dataset, and associate with each interval a representative value (denoted by tᵢ for the i th interval; e.g., its midpoint) and then associate each data point with the representative value of the interval it lies in. We use M discrete points for the travel times with M being sufficiently large to accommodate the largest possible travel times one may observe and account for the desired granularity of discretization; in practice, a second-by-second uniform discretization typically suffices. Without loss of generality, discretization determines the number M of kernels to use {ϕⱼ(⋅)}ⱼ₌₀^{M-1}, cf. (equation 5); we associate one kernel with each discrete travel time, i.e., kernel ϕⱼ(⋅) corresponds to discrete time tⱼ.

Mapping a Continuous t to its Discrete Representative.

Let τ(⋅) be a subjective mapping from the continuous interval [0,T] into the discrete set {t₀,Λ, t_{M-1}}, i.e., τ(⋅) performs the operation tαtᵢ. In words, the function τ(⋅) takes a continuous travel time t and returns its representative tᵢ in the discrete set. Then, we have for any t≥0 that

$$\overline{p} ( t ) ≡ {p}_{τ ( t )} = {\sum }_{j = 0}^{M - 1} {θ}_{j} {φ}_{j} ( τ ( t ) ) . \qquad ( 7 )$$

The locations of the M component densities simply constitute a set of travel times which are denoted by {tₘ}ₘ₌₀^{M-1}; note that these do not necessarily coincide with the discrete support of the distribution. Mixture components with variable width are considered so that that term may not have M distinction values. That is, some values coincide and M>N is possible. The distinct values in {tₘ}ₘ₌₀′^{M-1} are taking to be the subset of the discrete support of the distribution ∪ₘ₌₀^{M-1}{tₘ}⊆{tₙ}ₙ₌₀^{N-1}; denoting the number of the distinct values in the set {tₘ}ₘ₌₀^{′M′-1} by M′ we have necessarily M′≤N. for the single case of a scale parameter used it holds that M+M′≤N.

For model-fitting parameter estimation, we may derive a discrete generalized histogram (from both our model and Parzen density) by sampling the densities at discrete points, i.e., considering vectors \hat{p},p̅ obtained by evaluating \hat{p}(⋅),p̅(⋅)) at discrete times {tᵢ}. These times need not be the same as the discrete times considered for selecting the kernels, i.e., we may evaluate the densities at any discretized time, include those exceeding T; cf. the analysis in the next section. Consequently, we sample each continuous function ϕⱼ(⋅) to obtain a vector ϕ̅ⱼ, with elements ϕ̅ₜ_{ᵢ}_{,j}≡cᵢϕⱼ(tᵢ), where cᵢ is a constant that depends on the discretization and is allowed to vary if the disjoint intervals of the discretization vary. In essence, cᵢ is a measure of the width of the i th interval; for example, using a second-by-second uniform discretization and assuming that travel times are measured in seconds, we may set cᵢ=1 for all i. Recall that we may set ϕ₀(⋅)=c so that ϕ̅ₜ_{ᵢ}_{,0}≡c₀, i.e., we also allow for an additive constant (i.e., that does not depend on the time tᵢ) in the discretization. Note that we consider all indices for rows, columns and vector entries run from 0 to M−1 (as opposed to 1 to M) in accord with our construction.

In matrix form, we write

p̅=Φ̅θ, (8)

where Φ̅=└ϕ̅ₜ_{ᵢ}_{,j}┘∈R^{M×M} Φ̅=[ϕ̅ₜ_{ᵢ}_{,j}]∈ [symbol] ^{M×M} Φ̅=[ϕ̅ₜ_{ᵢ}_{,j}]∈ [symbol] ^{M×M} Φ̅=[ϕ̅ₜ_{ᵢ}_{,j}]∈ [symbol] ^{M×M} and p̅≡[p̅ₜ_{₀}Λp̅ₜ_{_{M-1}}]^{T} (where p̅ₜ_{ⱼ}≡cᵢp̅(tⱼ)). Discretizing the Parzen histogram in a similar way, \hat{p}≡[\hat{p}ₜ_{₀} . . . \hat{p}ₜ_{_{M-1}}]^{T} \hat{p}≡[\hat{p}ₜ_{₀} . . . \hat{p}ₜ_{_{M-1}}]^{T} \hat{p}≡[\hat{p}ₜ_{₀} . . . \hat{p}ₜ_{_{M-1}}]^{T} \hat{p}≡[\hat{p}ₜ_{₀} . . . \hat{p}ₜ_{_{M-1}}]^{T} (where \hat{p}ₜ_{ᵢ}≡cᵢ′\hat{p}(tᵢ)\hat{p}ₜ_{ᵢ}≡cᵢ′\hat{p}(tᵢ)\hat{p}ₜ_{ᵢ}≡cᵢ′\hat{p}(tᵢ)⁶\hat{p}ₜ_{ᵢ}≡cᵢ′\hat{p}(tᵢ)⁶ \hat{p}ₜ_{ᵢ}±cᵢ′(\hat{p}ₜ_{ᵢ})⁶), the estimation problem can be written as

$${minimize}_{θ ∈ Ω} \frac{1}{2} {‖ \hat{p} - \overline{Φ} θ ‖}_{2}^{2} + ω {‖ θ ‖}_{1} , \qquad ( 9 )$$

where the L₂ norm is the usual Euclidean norm, and ω≥0 is a parameter that controls the sparsity of the obtained estimate. The optimization problem in (9) is widely known as the Least Absolute Shrinkage and Selection Operator (LASSO) in statistics literature.

We note that equation (9) is the discrete counterpart of equation (6), but those two problems are not equivalent. One may directly solve equation (6), as a finite-dimensional optimization problem, however this would require excessive numerical integrations (computing inner products [symbol] p (⋅),ϕⱼ(⋅) [symbol] _{L}_{₂}_{(R)}, [symbol] ϕᵢ(⋅),ϕⱼ(⋅) [symbol] ₗ_{₂}_{(R)} [symbol] \hat{p}(⋅),ϕⱼ(⋅) [symbol] [symbol] , [symbol] ϕᵢ(⋅),ϕⱼ(⋅) [symbol] [symbol] ). Instead, we quantize time and values and obtain equation (9); effectively this is the rectangle rule for numerical integration (solution of equation (9) converges to that of equation (6) as the discretization step tends to zero).

4. Sparse Estimation with Gamma Kernels

The main feature that all kernel functions share is strong influence near observations, i.e., at t=tᵢ, and decreased influence as the distance |t−tᵢ| increases. Some commonly used kernels include the normalized Gaussian kernel, the bi-weight kernel, and the Epanechnikov kernel. While the use of these classical symmetric kernels is justified when the support of the underlying PDF is unbounded, they lead to poor estimates when the PDF has non-negative support (as is the case with travel times). Thus, some embodiments use Gamma kernels to overcome this issue. The probability density function (PDF) of Gamma distribution is given by:

$${p}_{G} ( t ; β , σ ) = \frac{1}{σ Γ ( β )} {( \frac{t}{σ} )}^{β - 1} {e}^{- \frac{t}{β}} , \qquad ( 10 )$$

where β>0 is a shape parameter, σ>0 is a scale parameter, and where Γ(⋅) is the Gamma function. We extend the Gamma kernel model proposed by Chen (2000) to allow for variable (sparse) weights. According to Chen (2000), to evaluate the probability density at t, the kernel uses a single Gamma PDF with its mode coinciding with t, evaluates the densities of the sample points using this single function, and then calculates a (uniformly) weighted average of these densities. This is in contrast to Gaussian kernels, which would place Gaussian densities at each of the discrete travel times tⱼ and then calculate a weighted average of the M function evaluations at t. That is, the roles of parameter and argument are reversed. The mode of a Gamma distribution is given by (β−1)σ. In order to locate the (mode of the) kernel at the argument t, the location parameter is set to Γ=1+(t/σ). Hence, the j th Gamma kernel function is given by

$${φ}_{j} ( t ) = {p}_{G} ( {t}_{j} ; 1 + \frac{t}{σ} , σ ) . \qquad ( 11 )$$

Note that for tⱼ=0 equation (10) would yield the function ϕ₀(⋅)=0, however we have replaced this with a constant finite-support kernel

$${φ}_{0} ( \cdot ) ≡ \frac{1}{T} > 0 ,$$

### on [0,T].

4.1 Discretization of the Gamma Kernel

In this section, we further discuss the appropriate normalization, i.e., how to select the constants {c₁} in constructing the ‘sensing’ matrix Φ̅, taking into consideration that probability densities need to sum to 1.

First note that the vector \hat{p}\hat{p} need not satisfy ∥\hat{p}∥₁=1∥\hat{p}∥₁=1 ∥\hat{p}∥₁=1∥\hat{p}∥₁=1, but does so approximately if the discretization is sufficiently fine-grained, and the travel times are concentrated away enough from T. For the Gamma kernel model, with Σⱼθⱼ=1, we require that

$${\sum }_{i} {c}_{i} {p}_{G} ( {t}_{j} ; 1 + \frac{{t}_{i}}{σ} , σ ) = 1$$

for each j (corresponding to a discrete travel time with which a single kernel is associated). One may be tempted to claim as before; that is approximately equal to 1, for fine-grained discretization and travel times concentrated away from T. However this is not the case (even though this needs to be the case for the resulting p̅).

For reasons that will be made clear below, we will choose two discretizations: one for {tⱼ}ⱼ and one for {tᵢ}ᵢ, abusing notation; the i and j indices will be used to differentiate between these two. The set {tᵢ} contains {tⱼ}ⱼ but extends beyond T. Specifically, the set {tⱼ} will remain the same as above: M discrete points, chosen on practical grounds, while |{tᵢ}|=N with N>>M N>>M. We choose a uniform discretization for both sets: we select a constant Δ>0 such that each tⱼ and each tᵢ can be expressed as tⱼ=j·Δ and t=i·Δ, respectively, with j∈{0,Λ,M−1} and i∈{0,λ,N−1}.

We now return to finding {cᵢ} so that Σᵢp̅ₜ_{ᵢ}≈1. Define \tilde{Δ}=Δ/σ Δ̅=Δ/σ Δ̅=Δ/σ. Then,

$${\sum }_{i = 0}^{N - 1} {c}_{i} {p}_{G} ( {t}_{j} ; 1 + \tilde{Δ} \cdot i , σ ) = {\sum }_{i = 0}^{N - 1} {c}_{i} \frac{1}{σ Γ ( 1 + \tilde{Δ} \cdot i )} {( \frac{{t}_{j}}{σ} )}^{\tilde{Δ} \cdot i} {e}^{- \frac{{t}_{j}}{σ}} . \qquad ( 12 )$$

Selecting the scale parameter so that \tilde{Δ}=1 \tilde{Δ}=1 Δ̅=1, i.e.,

$$σ ≡ \frac{1}{Δ} σ ≡ \frac{1}{Δ} ,$$

the above sum satisfies the desired property (summation to unity) for any tⱼ when cᵢ=σ for all i and N→∞. This holds since the terms inside the sum on the right hand side of equation (12) take the form of the probability mass function of a Poisson distributed random variable (When x is an integer, Γ(1+x)=x!.) with rate parameter tⱼ/σ. As such, we choose N so that the sum is approximately unity. This is done as follows: Let X be a Poisson random variable with rate parameter:

$${max}_{{\{ {t}_{j} \}}_{j = 0}^{M - 1}} \frac{{t}_{j}}{σ} = \frac{( M - 1 ) Δ}{σ} = M - 1. \qquad ( 13 )$$

If ε is an acceptable error threshold, then we choose N so that (X≥N)≥ε. This is simply the (1−ε)-percentile point of X. Specifically, N is chosen as follows:

N≡min{n:(X≥n)≤ε}. (14)

Note that: (i) choosing the rate parameter as maxⱼ tⱼ/σ renders our choice of N independent of tⱼ and ensures that the threshold error is not exceeded for any tⱼ; (ii) this is only achievable when N>M (possibly N>>M N>>M N>>M), which is the sole purpose of the two discretizations; and (iii) ensuring that Σᵢp̅ₜ_{ᵢ}=1 as opposed to it being approximately equal to unity can be achieved by adding a constant which depends on j to the kernel, ϕ̅_{0,j}≡εⱼ exp(−tⱼ/σ), where

$${ɛ}_{j} = {\sum }_{i = N}^{∞} \frac{1}{i !} {( \frac{{t}_{j}}{σ} )}^{i} . \qquad ( 15 )$$

It is notable that Gamma kernel density functions in the statistical literature do not, in general, integrate to unity. In other words

∫₀^{∞}p_{G}(tⱼ;1+(σ⁻¹t),σ)dt≠1 ∫₀^{∞}p_{G}(tⱼ;1+(σ⁻¹t),σ)dt≠1. This is a consequence of reversing the roles of parameter and argument. We give this issue close attention and ensure that our approach guarantees, at least in an approximate sense, that p̅ integrate to unity.

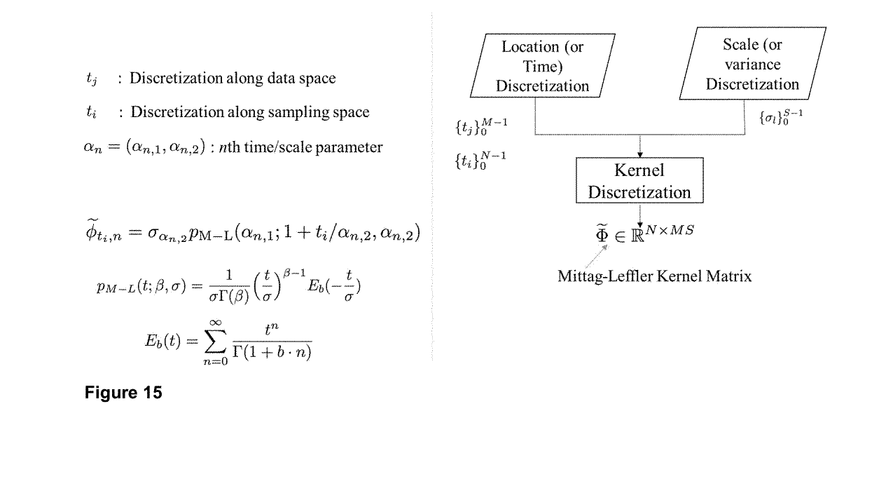

It is important to point out that the ‘normalization’ analysis in this and the following section is not just pedagogical, but has crucial practical implications. One may be tempted to simply normalize \hat{p} along with the columns of \hat{Φ} (to obtain a column-stochastic matrix) as preprocessing step. While this may be a valid option when travel times are concentrated sufficiently far away from the upper bound t_{M-1}, this approach is not valid when they are not, as it under-weighs the contribution of kernels corresponding to large travel times (by ignoring the kernel portion beyond t_{M-1}). In a practical setup, one key feature of our proposed method is event detection, based on the modes of the travel time distribution. For instance, an accident will result in substantial increase of the travel times, across a route, and in fact this is a means for a prompt detection at a system-level. In such scenarios, our recursive estimation method aims at effectively detecting drastic changes in travel time distributions by adaptively tracking the travel time dynamics. To that end, the contributions of kernels corresponding to larger travel times is crucial, and should not be neglected (as when considering {tᵢ}={tⱼ}). We further note that the exact same approach can be used to ‘normalize’ the sampled Parzen density \hat{p}, using the percentiles of the underlying kernel κₕ(t−t_{M-1}) (for example, the 3σ rule for Gaussians). To conclude, one needs to consider Φ̅∈R^{N×M}∈ [symbol] ^{N×M} and \hat{p}∈R^{N} \hat{p}∈ [symbol] ^{N} p ∈ [symbol] ^{N} p∈ [symbol] ^{N} by evaluating: ϕ̅ₜ_{ᵢ}_{,j}≡cᵢϕⱼ(tᵢ) and \hat{p}ₜ_{ᵢ}=cᵢ′\hat{p}(t₁)\hat{p}ₜ_{ᵢ}≡cᵢ′\hat{p}(tᵢ)\hat{p}ₜ_{ᵢ}≡cᵢ′\hat{p}(tᵢ), where i=0, N−1, j=0, M−1. The first column of the matrix {ϕ̅ₜ_{ᵢ}_{,0}}ᵢ is equal to N⁻¹1, where 1 denotes the vector with all entries equal to one. The first row (with the exception of entry ϕ̅_{0,0}) is given by ϕ̅_{0,j}≡εⱼ exp(−tⱼ/σ) through equation (15). FIG. 15 provides an illustration of the process for Gamma kernels.

4.2. A Generalized Gamma Kernel Using Mittag-Leffler Functions

One drawback of the approach outlined above is the single scale parameter σ. To allow for kernel functions with variable scale parameters we consider scale parameters in a discrete set (as was done with the discrete time parameters tᵢ). However, before we can do so, we need to address the issue of the units of measurement. That is, the assumption that \tilde{Δ}=1\tilde{Δ}=1\tilde{Δ}=1 is no longer feasible, since σ is allowed to vary from one kernel to another.

To address this issue and ensure that the sparse density is indeed a probability density, we generalize the Gamma kernel to one which uses a generalized form of the exponential function. This can be achieved by replacing exp(−t/σ) in equation (10) with the reciprocal of the (scaled) Mittag-Leffler function, give E_{b}(⋅)n by

$${E}_{b} ( t ) = {\sum }_{n = 0}^{∞} \frac{{t}^{n}}{Γ ( 1 + b \cdot n )} . \qquad ( 16 )$$

The exponential function is a special case of the Mittag-Leffler function, obtained when b=1; i.e., E₁(t)=exp(t). The elements of the generalized kernel matrix, which we will name the Mittag-Leffler (M-L) kernel are then calculated as

$${{φ}^{}}_{{t}_{i} , j} = {c}_{i} {p}_{M - L} ( {t}_{j} ; 1 + \tilde{Δ} \cdot i , σ ) = {c}_{i} \frac{1}{σΓ ( 1 + \tilde{Δ} \cdot i )} {{( \frac{{t}_{j}}{σ} )}^{\tilde{Δ} \cdot i} [ {E}_{\tilde{Δ}} ( {( \frac{{t}_{j}}{σ} )}^{\tilde{Δ}} ) ]}^{- 1} . \qquad ( 17 )$$

The right-hand side of (17) is the probability mass function of a generalized hyper-Poisson random variable. Specifically, let \tilde{X}\tilde{X} denote such a random variable and let p_{\tilde{X}}(⋅;a,b)p_{X}(⋅;a,b) denote its probability mass function, where a and b are the parameters of the distribution. Then

$$ℙ ( \tilde{X} = n ) ≡ {p}_{\tilde{X}} ( n ; a , b ) = {a}^{n} \frac{1}{Γ ( 1 + b \cdot n ) {E}_{b} ( a )} . \qquad ( 18 )$$

Setting a≡(tⱼ/σ)^{\hat{Δ}} b≡\tilde{Δ}b=\tilde{Δ}b, b≡\hat{Δ}, and cᵢ=σ for all i, we have that

$${{φ}^{(}}_{j , {t}_{i}}$$

in equation (17) is a probability mass function of some discrete random variable. Since this random variable depends on j, we denote it by \tilde{X}ⱼ\tilde{X}ⱼ\tilde{X}ⱼ\tilde{X}ⱼ. In a similar manner to the Gamma kernel, set

N≡min{n: [symbol] (\tilde{X}ⱼ≥n)≤ε, j=0, . . . ,M−1}=min{n: [symbol] (\tilde{X}_{M-1}≥n)≤ε}, (19)

for some tolerance ε. Consequently, we have that

$${\sum }_{i = 0}^{N - 1} \approx 1 and {\sum }_{i = 0}^{N - 1} = 1$$

if we use

$${{φ}^{}}_{0 , j} ≡ {[ {E}_{\tilde{Δ}} ( {( {t}_{j} / σ )}^{\tilde{Δ}} ) ]}^{- 1} {\tilde{ɛ}}_{j} , \\ where \\ {\tilde{ɛ}}_{j} = {\sum }_{i = N}^{∞} \frac{1}{Γ ( 1 + \tilde{Δ} \cdot i )} {( \frac{{t}_{j}}{σ} )}^{\tilde{Δ} \cdot i} . \qquad ( 20 )$$

FIG. 15 (right side) provides an illustration of the process for Mittag-Lefler kernels.

4.3. Adaptive Kernels

To allow for kernel functions with variable scale parameters we consider scale parameters in a discrete set (as was done with the discrete time parameters tᵢ). The weights are extended to include pairings of time and scale parameters. That is, we now allow θ_{j,l}, which represents the weight associated with a kernel function with time parameter tⱼ and scale parameter σₗ. This is sometimes referred to as adaptive kernel estimation (Van Kerm, 2003).

4.3.1. Adaptive Estimation Problem

Let l take values in 1,Λ,S, then the generalized Gamma kernel density (using Mittag-Leffler functions) takes the form:

$$\overline{p} ( t ) = {\overline{p}}_{τ ( t )} = {\sum }_{l = 0}^{S - 1} {\sum }_{j = 0}^{M - 1} {θ}_{j , l} ( {φ}_{τ ( t ) , j}^{l} = {\sum }_{l = 0}^{S - 1} {\sum }_{j = 0}^{M - 1} {θ}_{j , l} {c}_{i} {p}_{M - L} ( {t}_{j} ; 1 + \frac{τ ( t )}{{σ}_{l}} , {σ}_{l} ) , \qquad ( 21 )$$

where τ(t)=Δ·i for some i∈{0,Λ,N−1}. For each (j,l) pair, letting \tilde{Δ}ₗ≡Δ/σₗ \tilde{Δ}ₗ≡Δ/σₗ \tilde{Δ}ₗ≡Δ/σₗ \tilde{Δ}ₗ≡Δ/σₗ we have that

$${\sum }_{i = 0}^{N - 1} {c}_{i} {p}_{M - L} ( {t}_{j} ; 1 + {\tilde{Δ}}_{l} \cdot i , {σ}_{l} ) \approx 1 , \qquad ( 22 )$$

by choosing cᵢ=σₗ as demonstrated in above. Hence,

$${\sum }_{i = 0}^{N - 1} {\sum }_{l = 0}^{S - 1} {\sum }_{j = 0}^{M - 1} {θ}_{j , l} {σ}_{l} {p}_{M - L} ( {t}_{j} ; 1 + {\tilde{Δ}}_{l} \cdot i , {σ}_{l} ) = {\sum }_{l = 0}^{S - 1} {\sum }_{j = 0}^{M - 1} {θ}_{j , l} {\sum }_{i = 0}^{N - 1} {σ}_{l} {p}_{M - L} ( {t}_{j} ; 1 + {\tilde{Δ}}_{l} \cdot i , {σ}_{l} ) \approx 1 \qquad ( 23 )$$

provided that Σₗ₌₀^{S-1}Σⱼ₌₀^{M-1}θ_{j,l}=1. Let αₙ=(α_{n,1},α_{n,2}) denote the nth time/scale parameter pair; there are P=S·M such parameter pairs. Then, equation (21) can be written more succinctly as:

$$\overline{p} ( t ) = {\overline{p}}_{τ ( t )} = {\sum }_{n = 0}^{P - 1} {\tilde{θ}}_{n} {\tilde{φ}}_{τ ( t ) , n} = {\sum }_{n = 0}^{P - 1} {\tilde{θ}}_{n} {σ}_{l} {p}_{M - L} ( {α}_{n , 1} ; 1 + \frac{τ ( t )}{{α}_{n , 2}} , {α}_{n , 2} ) , \qquad ( 24 )$$

where \tilde{θ}ₙ is the weight associated with the nth time/scale pair and

$${\tilde{φ}}_{{t}_{i} , n} = {σ}_{{α}_{n , 2}} {p}_{M - L} ( {α}_{n , 1} ; 1 + {t}_{i} / {α}_{n , 2} , {α}_{n , 2} ) .$$

The (adaptive) kernel estimation problem is then:

$${minimize}_{\tilde{θ} ∈ \tilde{Ω}} \frac{1}{2} {‖ \hat{p} - \tilde{Φ} \tilde{θ} ‖}_{2}^{2} + ω {‖ \tilde{θ} ‖}_{1} , \qquad ( 25 )$$

where \tilde{Φ}∈ [symbol] ^{N×P} is the modified kernel matrix and \tilde{θ}∈\tilde{Ω}= [symbol] ₊^{P} is the modified weight vector. The problem equation (25) falls under the class of linearly constrained LASSO problems. There exist a plethora of both classical and contemporary algorithmic tools that can be used to solve this problem and specifically for problems of high dimensionality (James et al., 2013; Duan et al., 2016). The dimensionality of the problem becomes a concern when dealing with real-time applications (i.e., streaming data). This issue is addressed below. Note that equation (25) does not impose the condition: Σₙ₌₀^{P-1}\tilde{θ}ₙ=1. Imposing such a condition would nullify the regularization ω∥\tilde{θ}∥₁λ∥\tilde{θ}∥₁λ∥\tilde{θ}∥₁ in equation (25) (in such cases this is simply equal to ω, a constant independent of \tilde{θ}), thus reducing the flexibility of imposing sparsity by controlling the parameter ω. We overcome this issue with a simple post-processing procedure which we present next.

4.3.2. Ensuring Summability to One

Let [θ₀*Λθ_{P-1}*]^{T} solve equation (25) and suppose Σₙ₌₀^{P-1}θₙ*<1. We will not consider the case Σₙ₌₀^{P-1}θₙ*>1 as it is unlikely in practice given that ∥\hat{p}∥₁≈1 ∥\hat{p}∥₁≈1 ∥\hat{p}∥₁≈1 and that \tilde{Φ} is column-stochastic, and can be addressed in a similar manner. To address the summability to one issue, we may append a kernel to the solution with negligible impact on the outcome. Consider the kernel vector Ψ(t′,σ′)∈ [symbol] ^{N}, the elements of which are given by

$${ψ}_{{t}_{i}} ( {t}^{′} , {σ}^{′} ) ≡ {σ}^{′} {p}_{M - L} ( {t}^{′} ; 1 + \frac{{t}_{i}}{{σ}^{′}} , {σ}^{′} ) , \qquad ( 26 )$$

and the parameters, t′ and σ′, are chosen in a way that ε≥ψₜ_{ᵢ}(t′,σ′) for all i=0,Λ,N−1 and some predefined tolerance threshold ε>0. Equivalently, we may choose t′ and σ′ so that

$${max}_{{t}_{0} , Λ , {t}_{N - 1}} {ψ}_{{t}_{i}} ( {t}^{′} , {σ}^{′} ) \leq ɛ . \qquad ( 27 )$$

Define Δ′≡(σ′)⁻¹Δ so that ψₜ_{ᵢ}(t′,σ′)=σ′p_{M-L}(t′;1+Δ′·i,σ′). We first note that ψₜ_{ᵢ}(t′,σ′) is a unimodal function in i. Hence, i*=arg max_{i∈{0,Λ,N-1}}p_{M-L}(t′;1+Δ′·i,σ′) is unique. Consider a choice of t′ and σ′ so that t′/σ′=1. Then

$${argmax}_{i ∈ \{ 0 , Λ , N - 1 \}} {p}_{M - L} ( {t}^{′} ; 1 + {Δ}^{′} \cdot i , {σ}^{′} ) = {argmax}_{i ∈ \{ 0 , Λ , N - 1 \}} \frac{1}{Γ ( 1 + {Δ}^{′} \cdot i ) {E}_{{Δ}^{′}} ( 1 )} = {argmin}_{i ∈ \{ 0 , Λ , N - 1 \}} Γ ( 1 + {Δ}^{′} \cdot i ) . \qquad ( 28 )$$

A well-known property of the Gamma function is that it achieves a local minimum in ₊, which is Γ(xₘᵢₙ)=0.885603 for xₘᵢₙ=1.461632. Another property is that |I^{&}(xₘᵢₙ−)|>|I^{&}(xₘᵢₙ+)|. Consequently,

$${argmin}_{i ∈ \{ 0 , Λ , N - 1 \}} Γ ( 1 + {Δ}^{′} \cdot i ) = ⌊ \frac{0.461632 {σ}^{′}}{Δ} ⌋ . \qquad ( 29 )$$

We now have that

$${max}_{{t}_{0} , Λ , {t}_{N - 1}} {ψ}_{{t}_{i}} ( {t}^{′} , {σ}^{′} ) \leq \frac{1}{0.886 {E}_{{Δ}^{′}} ( 1 )} \qquad ( 30 )$$

so that σ′ is chosen to ensure that

$${E}_{\frac{Δ}{{σ}^{′}}} ( 1 ) \leq \frac{1}{0.886 ɛ} . \qquad ( 31 )$$

We now append ψ(t′,σ′) to Φ̅ and set θ=[θ*^{T}, 1−Σₙ₌₀^{P-1}θₙ*]^{T}.

Notice that the choice of σ′ above does not depend on θ*. Therefore, this calculation can be performed offline. However, we require that └0.461632σ′/Δ┘∈{0,Λ,N−1}. One way to ensure this is satisfied is to choose t′=σ′=2Δ(M−1) as long as N≥2M, which can be easily accommodated by design.

Since θ_{P}=1−Σₙ₌₀^{P-1}θₙ*<1, we have that the contribution of ψ(t′,σ′) at i*. (where it assumes its maximum value) to p̅ is strictly smaller that ε; it is hence strictly smaller than ε everywhere in the support of p̅.

5. Practical Considerations

5.1. Numerical Optimization

LASSO equation (9) is a convex program (Boyd and Vandenberghe, 2004) and there exist a multitude of numerical schemes for solving it. Aside from generic convex solvers, such as CVX (Grant and Boyd, 2014), many numerical optimization methods have been developed to solve the problem. These include applications of the fast proximal gradient method of (Nesterov, 2013) such as (Beck and Teboulle, 2009; Wright et al., 2009), applications of the Alternating Direction Method of Multipliers (ADMM) (Parikh and Boyd, 2014) such as (Afonso et al., 2010), and interior point methods such as (Kim et al., 2007).

Recently, a quasi-Newton solver featuring substantial acceleration for high-accuracy solutions was devised by (Sopasakis et al., 2016). Note that these methods were all derived for the unconstrained LASSO (i.e., Ω= [symbol] ^{M} Ω= [symbol] ^{M}). We consider Ω=₊^{M} Ω=₊^{M}Ω= [symbol] ₋^{M}, i.e., a constrained LASSO problem (non-negative weights). Again aside from CVX (which may be substantially slower as generic solver), we may modify the aforementioned algorithms to handle the constrained LASSO. In fact note that for Ω= [symbol] ₊^{M}Ω= [symbol] ₋^{M} the problem becomes:

$${minimize}_{θ \geq 0} \frac{1}{2} {‖ \hat{p} - Φ θ ‖}_{2}^{2} + ω {1}^{⊤} θ , \qquad ( 32 )$$

which has a differentiable objective. We have implemented a fast projected gradient method for this problem as well as a log-barrier interior-point method based on the analysis in (Kim et al., 2007).

For the interior-point method we define the logarithmic barrier for the non-negative constraints as −Σᵢ₌₁^{P} log(θᵢ) over the domain R^{P} [symbol] ^{P} [symbol] ^{P} and augment the weighted objective function, to obtain the associated centering problem

$${minimize}_{θ ∈ Ω} \frac{t}{2} {‖ \hat{p} - Φ θ ‖}_{2}^{2} + t ω {\sum }_{i = 1}^{P} {θ}_{i} - {\sum }_{i = 1}^{P} log ( {θ}_{i} ) . \qquad ( 33 )$$

For each instance of constrained LASSO, we solve a sequence of these problems for increasing t (the two problems are equivalent as t→+∞).

5.2. Choice of Regularization Parameter

The regularization parameter, ω, controls the trade-off between sparsity and reconstruction error. If the regularization parameter ω is sufficiently large, most of the coefficients are driven to zero, leading to a sparse model with only a few (relevant) kernel functions; however this typically leads to a poor fitting accuracy. On the other hand, when ω is sufficiently small, one retrieves the best possible fit (constrained least-squares), which is non-sparse (all coefficients are non-zero). In selecting ω, the aim is to balance the trade-off between goodness-of-fit and sparsity. The problem of choosing the appropriate regularization parameter is crucial as it governs the selection of the sparsest model that can faithfully reconstruct the underlying distribution of the data. One approach to selecting a suitable ω, which makes good use of the available dataset (Efron and Gong, 1983; Turney, 1994), is k-fold cross-validation. However, cross-validation techniques do not promote sparsity, in general, but are rather geared towards avoiding overfitting, which differs from sparsity. Moreover, cross-validation does not lead to consistent model selection for LASSO.

We propose a simple scheme for tuning the parameter ω to balance the trade-off between sparsity and goodness-of-fit. For this purpose, we use a metric inspired by the analysis in (Reid et al., 2013; Sun and Zhang, 2012) on scaled-LASSO:

$${S}_{ω}^{2} ≡ \frac{1}{P - {\hat{s}}_{ω}} {‖ \hat{p} - Φ {\hat{θ}}_{ω} ‖}_{2}^{2} , \\ {S}_{λ}^{2} = \frac{1}{P - {s}_{λ}} {‖ \hat{p} - Φ {\hat{θ}}_{2} ‖}_{2}^{2} \qquad ( 34 )$$

where ŝ_{ω}=|sup(\tilde{θ}_{ω})| ŝ_{ω}=|sup(\tilde{θ}_{ω})| ŝ_{λ}=|sup(\tilde{θ}_{λ})| ŝ_{λ}=|sup(\tilde{θ}_{λ})| ŝ_{λ}=|sup(\tilde{θ}_{λ})| is the number of non-zero entries of \tilde{θ}_{λ}\tilde{θ}_{λ} (i.e., the cardinality of its support—the set of non-zero entries denoted by sup(⋅)) and we use \tilde{θ}_{ω} to emphasize the dependence of the LASSO solution on the regularizing parameter ω. The metric, S_{λ}²S_{λ}², in equation (34) captures the trade-off between goodness-of-fit as measured by the squared λ₂−error ∥p−Φ\tilde{θ}_{ω}∥₂² ∥p−Φ\tilde{θ}_{ω}∥₂² ∥p−Φ\tilde{θ}_{ω}∥₂² ∥p−Φ\tilde{θ}_{ω}∥₂² and sparsity (P−ŝ_{ω}) (P−ŝ_{λ}) (P−ŝ_{ω}) (P−ŝ_{λ})(the number of zeros in the solution \hat{θ}). The metric S_{ω}² is directly proportional to the squared λ₂−error and inversely proportional to the sparsity (number of zeros of the solution). Note also that S_{ω}²S_{λ}² is well-defined for ŝ_{ω}ŝ_{λ}<Pŝ_{λ}<P, i.e., it is not defined for values of ω close to 0. Formally, S_{ω}² is defined on a set (ωₘᵢₙ,+∞) for some ωₘᵢₙ>0; this is because of the continuity of solutions in ω which guarantees that sparsity (belonging to a discrete set {0,Λ,P}) is piecewise constant and increasing in ω.

For ω=0, one retrieves the constrained least-squares solution:

$${minimize}_{θ \geq 0} {‖ \hat{p} - Φ θ ‖}_{2}^{2} , \qquad ( 35 )$$

which serves as a lower bound for squared λ₂−error (best possible goodness-of-fit) but is known to be non-sparse (ŝ_{ω}=Pŝ_{λ}=Pŝₗ=Pŝₗ=P in most cases). For ω>ω₀ where

ω₀≡∥Φ^{T}\hat{p}∥_{∞}, (36)

the all-zero solution is retrieved (ŝ_{ω}=P ŝₗ=P ŝₗ=P); this maximizes sparsity but yields a squared λ₂−error equal to ∥p∥₂²∥p∥₂²∥p∥₂².

One may then search over variable values of ω based on the aforementioned analysis. For example, we may consider variable values of ω in a logarithmic scale: starting from ω₀ and evaluating S_{ω}² for values ωₖ=η^{k}ω₀ for some η∈(0,1), e.g., η=0.95, where k is successively increased until the all-zero solution is obtained (ŝ_{ω}=0 s̅_{λ}=0) One example is to select the value of ω that minimizes S_{ω}² over the variable values selected. This is can be done as a pre-processing step to all the sparse estimation problems that are described herein (for instance, this has to be done once, offline, in the streaming case that we discuss in the next section). One embodiment may use:

$$\frac{{‖ \hat{p} - Φ θ ( {w}_{k + 1} ) ‖}_{2} - {‖ \hat{p} - Φ θ ( {w}_{k} ) ‖}_{2}}{{‖ \hat{p} - Φ θ ( {w}_{k} ) ‖}_{2}} < {ϵ}^{′} ,$$

with ϵ′=10⁻³. An alternative is to achieve a desirable sparsity level exactly by means of the search mechanism above in conjunction with bisection.

5.3. Post-Processing

Once a numerical solution of LASSO equation (32) is obtained, it is important to numerically post-process it. For example, when we mention ‘zero’ values in the solution vector \hat{θ} \hat{θ}, this corresponds to very small entries. One simple, yet efficient way to define the zero entries of \hat{θ}\hat{θ} is by thresholding, e.g., setting all entries |θᵢ|<ε∥\hat{θ}∥_{∞} |θᵢ|<∈∥\hat{θ}∥_{∞} |θᵢ|<∈∥\hat{θ}∥_{∞} |θᵢ|<∈∥\hat{θ}∥_{∞}, for some small value of ε, e.g. ε=10⁻³ We denote the resulting solution by to emphase the fact that \hat{θ} is the final solution obtained after post-processing. After thresholding, the support of the solution, sup(\hat{θ})supp(\hat{θ}),supp(\hat{θ}) (set of non-zero entries) is finalized. Once this is done, we may improve the reconstruction fidelity, by performing constrained least-squares on this support: i.e., we obtain a new matrix Φₛ as the set of columns of Φ belonging in the support, and run constrained least-squares to update the entries \hat{θ}ₛ\hat{θ}ₛ

$${minimize}_{{θ}_{s} \geq 0} {‖ \hat{p} - {Φ}_{s} {θ}_{s} ‖}_{2}^{2} . \qquad ( 37 )$$

This is usually referred to as a de-biasing step. We denote the resulting final solution (after thresholding and de-biasing) by \hat{θ} \hat{θ}.

6. Recursive Estimation

The sparse density estimation methods that we have presented thus far implicitly assume that the travel times are all available at the time of data processing. This is an inherent issue with traditional compressed sensing approaches that are naturally offline methods. In order to capture real-time variation in travel time (due for instance to recurrent or non-recurrent events), this section presents an efficient online algorithm that operates directly on streaming measurements. Our approach closely follows and extends the work of Freris et al. (2013) and Sopasakis et al. (2016) in recursive compressed sensing.

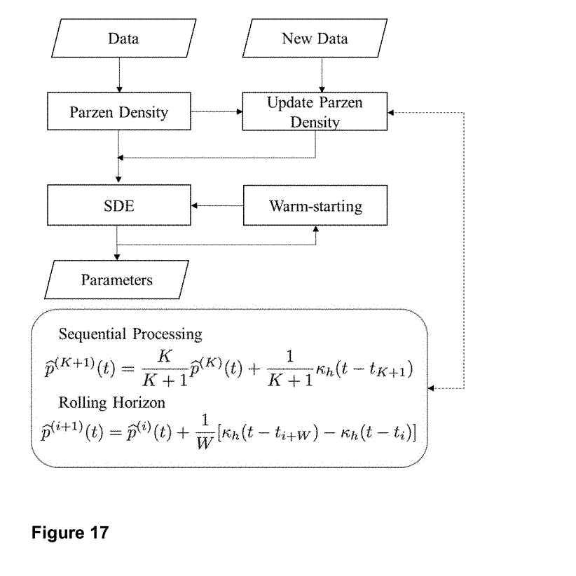

The key observation is that the dimensionality of our problem (size of θ) does not depend on the size of the dataset. The parameter size M (P for M-L kernels) and Parzen sample size N all solely depend entirely on the time (and scale parameter for M-L kernels) discretization. For efficient sparse kernel density estimation using streaming data it is important to devise a method that (a) efficiently updates the Parzen densities based on new measurements and (b) provides fast numerical solutions to the LASSO problem (32). Satisfying these two requirements would guarantee that the resulting method is suitable for an online implementation subject to high frequency streaming measurements and stringent real-time constraints in updating density estimates. To accomplish the second requirements, we propose using warmstarting in solving equation (32), i.e., use the previously obtained estimate \hat{θ}\hat{θ} as an starting point to an iterative LASSO solver, while updating the Parzen vector \hat{p} \hat{p}. This is advantageous and leads to a substantial acceleration, particularly when combined with the semismooth Newton method of Sopasakis et al. (2016). We demonstrate this experimentally in Sec. 7.2.2. We showcase how the first requirement can be satisfied by considering two scenarios: (i) streaming processing of travel times, i.e., more data become available from the ‘same’ underlying density, whence the changes in estimated parameter \hat{θ}\hat{θ} reflect enhancing the estimation accuracy, and (ii) a rolling-horizon setup, in which data are time series and are processed via windowing (Freris et al., 2013). In such case the underlying distribution is considered time-varying and the scope is to ‘track’ its parameters, in real-time. This second scenario provides a data analytics method that captures travel time variability during a given day, or from day-to-day within a week or month (for a given time horizon per day). It is notable that parameter tracking can be used for anomaly detection, i.e., identifying accidents based on sudden changes in the travel time distribution. FIG. 17 illustrates one embodiment for streaming spare density estimation.

We briefly discuss the two scenaria in the following. We assume, without any loss in generality, that the online algorithm accepts streaming travel time data and processes the data one observation at a time.

6.1. Sequential Data Processing

We consider an ‘infinite’ stream of travel time data {t₁,t₂,Λ}. These times are not to be confused with the discretized times used for sampling the kernels/Parzen density as described above but rather correspond two those used for obtaining the Parzen density, i.e., the data histogram. Sequential streaming amounts to learning the underlying kernels corresponding to using the first K+1 data points based on the estimated kernels using the first K ones, for K∈Z₊ K∈Z₊. The K th LASSO problem is

$${\hat{θ}}^{( K )} ∈ {argmin}_{θ \geq 0} \frac{1}{2} {‖ {\hat{p}}^{( K )} - Φ θ ‖}_{2}^{2} + ω {1}^{⊤} θ . \qquad ( 38 )$$

Note again that the kernel matrix Φ does not depend on K, but solely depends on our choices of time (and the scale parameter for the M-L kernels) discretization. As explained above, we use warmstarting to obtain the solution \hat{θ}^{(K+1)} \hat{θ}^{(K+1)} \hat{θ}^{(K+1)} while using as starting point to our numerical solver the previous solution \hat{θ}^{(K)} \hat{θ}^{(K)}. The Parzen density is recursively updated as follows:

$${\hat{p}}^{( K + 1 )} ( t ) = \frac{K}{K +} {\hat{p}}^{( K )} ( t ) + \frac{1}{K + 1} {κ}_{h} ( t - {t}_{K + 1} ) . \qquad ( 39 )$$

Therefore, the vector \hat{p}^{(K+1)} \hat{p}^{(K+1)} \hat{p}^{(K+1)} can be obtained from \hat{p}^{(K)} \hat{p}^{(K)} \hat{p}^{(K)} along with the new data point t_{K+1} t_{K+1} t_{K+1} using exactly N operations (additions and multiplications). Since we consider discretized data, the values κₕ(t−tᵢ) can be precomputed, and depend only on time discretization.

6.2. Rolling-Horizon Data Processing

This recursive scheme allows real-time data to be incorporated into the model as they arrive, and gradually removes old data that becomes irrelevant. This is achieved by sampling the input stream recursively via overlapping windowing, as introduced in (Freris et al., 2013), rather than using all historical data available to learn the model parameters. This enables the sparse density model to adapt to changes in the underlying distribution (due, for example, to within-day and day-to-day variation in traffic conditions) of the data.

We define t⁽ⁱ⁾ to be the i th window taken from the streaming travel time data. Without loss of generality, we will assume a fixed window of length W, and for a travel time data stream {t₁,t₂,Λ,tᵢ,tᵢ₊₁,Λ}, we define t⁽ⁱ⁾∈{tᵢ,Λ,t_{i+W-1}} and, similarly, t⁽ⁱ⁺¹⁾≡{tᵢ₊₁,Λ,t_{i+W}} to be consecutive windows. Denoting the Parzen density corresponding to t⁽ⁱ⁾ by \hat{p}⁽ⁱ⁾\hat{p}⁽ⁱ⁾, learning in the i th window amounts to solving

$${\hat{θ}}^{( i )} ∈ {argmin}_{θ \geq 0} \frac{1}{2} {‖ {\hat{p}}^{( i )} - Φ θ ‖}_{2}^{2} + ω {1}^{⊤} θ . \qquad ( 40 )$$

Noting the overlap between two consecutive windows, the {\hat{θ}⁽ⁱ⁾} {\hat{θ}⁽ⁱ⁾} sequence of parameters can be estimated recursively: by leveraging the solution obtained for window i into obtaining a starting point for an iterative solver for LASSO in window i+1. The Parzen density estimate at any time t for the i th window is given as:

$${\hat{p}}^{( i )} ( t ) = \frac{1}{W} {\sum }_{j = i}^{i + W - 1} {κ}_{h} ( t - {t}_{j} ) . \qquad ( 41 )$$

Thus, the empirical PW estimator can be viewed as a sliding kernel estimator, with a shifted kernel κₕ(t−t_{i+W}) being added for every successive window, while the outdated kernel κₕ(t−tᵢ) is removed, i.e.,

$${\hat{p}}^{( i + 1 )} ( t ) = {\hat{p}}^{( i )} ( t ) + \frac{1}{W} [ {κ}_{h} ( t - {t}_{i + W} ) - {κ}_{h} ( t - {t}_{i} ) ] . \qquad ( 42 )$$

Again, the vector \hat{p}⁽ⁱ⁺¹⁾ \hat{p}⁽ⁱ⁺¹⁾ \hat{p}⁽ⁱ⁺¹⁾ \hat{p}⁽ⁱ⁺¹⁾ can be obtained from \hat{p}⁽ⁱ⁾ \hat{p}⁽ⁱ⁾\hat{p}⁽ⁱ⁾ using exactly O(N) operations (2N additions and N multiplications).

Owing to the substantial overlap between consecutive data windows, the optimal solution to the (i+1) th problem is expected to be close to that of the previous problem. This leads to substantial acceleration in solving successive LASSO problems, as demonstrated below.

7. Testing and Validation of the Proposed Approach

In this section, we present numerical experiments that demonstrate the merits of our methods on real-life datasets.

7.1. Numerical Testing

We first tested the performance of the proposed approach on a synthetic dataset, using a known bimodal probability density. The example we consider compares the performance of a Gaussian mixture and the proposed mixture density using M-L functions. For this example, a data set of S randomly drawn samples was used to construct the density estimate and a separate (out of sample) test data set of size Sₜₑₛₜ was used to calculate the out-of-sample rooted-mean square error (RMSEₒₒₛ) defined by

$${RMSE}_{oos} = \sqrt{\frac{1}{{S}_{test}} {\sum }_{j = 1}^{{S}_{test}} {( \hat{p} ( {t}_{j} ) - \overline{p} ( {t}_{j} ) )}^{2}} .$$

The (true) density to be estimated is given by a mixture of two densities: a Gaussian and a Laplacian with equal weights (0.5):

$$p ( t ) = 0.5 \frac{1}{\sqrt{200 π}} {e}^{- \frac{{( t - 60 )}^{2}}{200}} + 0.5 \frac{0.2}{2} {e}^{- 0.2 \vert t - 30 \vert} .$$

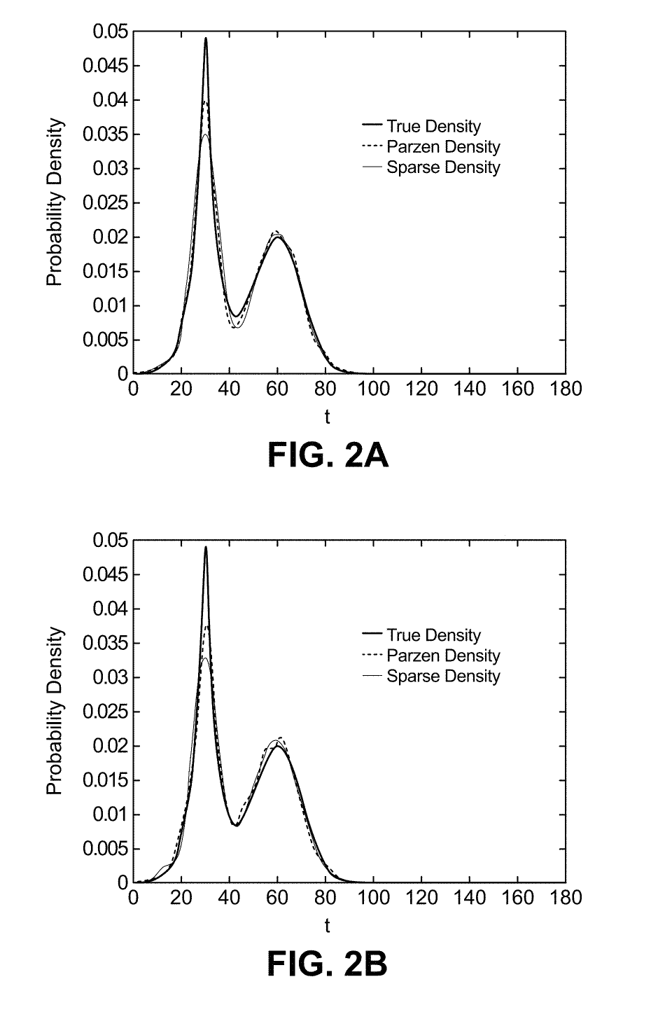

The density estimation was carried out using a data sample of size S=2000, while the error is reported for an out-of-sample dataset with Sₜₑₛₜ=10,000. For travel times, we considered uniform per-second discretization of the interval [1,300]s, i.e., M′=300. The scale parameter σₘ was allowed ten values {1, 2, . . . , 10} (therefore M=10M′=3000) for both Gaussian and M-L mixture densities. For both cases, we set N=2M′=600, corresponding to uniform per-second discretization of the interval [1,600] seconds. For this example, all computations were performed using Matlab and CVX (Grant and Boyd, 2014) for numerical optimization. The test was performed ten times and average values are reported. A representative comparison between the density obtained using our proposed approach (for both Gaussian and M-L kernels), the PW density (using Gaussian kernel with variance h=1.5), and the true density is presented in FIG. 2.

From this figure, it is evident that the sparse mixture estimators provide a very good fit to the true distribution, as is also shown in Table 1 (where RMSEₒₒₛ is reported within ±1 standard deviation). The achieved sparsity was less than 5% and 0.4% of the sample sizes in the case of the Gaussian and M-L cases, respectively. This indicates that using M-L mixture densities promotes higher sparsity than using Gaussian mixture densities, i.e., higher compression rate, while at the same time achieving an order of magnitude improvement in goodness-of-fit, cf. Table 1. In fact, the proposed sparse ML estimator even outperformed PW in terms of accuracy, which perfectly demonstrates the superior fitting capabilities of our model.

TABLE 1
Performance comparison on synthetic data.

| | | Number of mixture |
|---|---|---|
| Method | RMSE_{OOS} | components |
| PW estimator | 5.50e−04 ± 9.96e−05 | 2000 |
| Sparse Gaussian estimator | 3.3e−03 ± 1.92e−05 | 95 |
| Sparse M-L Estimator | 4.49e−04 ± 1.16e−04 | 7 |

7.2. Experiments on Real Datasets

In this section, we test the merits of our approach on real-life datasets.

7.2.1. Dataset

The sparse mixture density estimation approach proposed was applied to travel times extracted from vehicle trajectories made available by the Next Generation SIMulation (NGSIM) program Peachtree Street dataset. The arterial section is approximately 640 meters (2100 feet) in length, with five intersections and two or three through lanes in each direction. The section is divided into six intersection-to-intersection segments which are numbered from one to six, running from south to north. Of the five intersections, four are signalized while intersection 4 is un-signalized. The Peachtree Street data consists of two 15-minute time periods: 12:45 p.m. to 1:00 p.m. (noon dataset) and 4:00 p.m. to 4:15 p.m. (PM dataset). The dataset includes detailed individual vehicle trajectories with time and location stamps, from which the travel times of individual vehicles on each link were extracted. In this study, the link travel time is the time a vehicle spends from the instant it enters the arterial link to the instant it passes the stop-bar at the end of the link (i.e., the time spent at intersections is excluded).

The second dataset we used contains vehicle trajectory data collected under the NGSIM program on eastbound I-80 in the San Francisco Bay area in April 2005. The study area is approximately 500 meters in length and consists of six expressway lanes, including a high-occupancy vehicle (HOV) lane and an on-ramp (see Punzo et al. (2011) for details). Using seven cameras mounted on top of a 30-story building adjacent to the expressway, a total of 5648 vehicle trajectories were captured on this road section in three 15-minute intervals: 4.00 p.m. to 4.15 p.m.; 5.00 p.m. to 5:15 p.m.; and 5:15 p.m. to 5.30 pm. These periods represent the build-up of congestion, the transition between uncongested and congested conditions, and full congestion during the peak period, respectively.

7.2.2. Fitting Results and Comparisons

In order to demonstrate the effectiveness of the proposed approach, we have chosen to estimate the travel time distributions of southbound traffic on the signalized arterial links along Peachtree Street for the two time periods. We used Gaussian component densities for the empirical distribution \hat{p} (the PW density), where the bandwidth h was calculated according to the (standard) approximation proposed by Silverman (1986): h=1.06çS^{-1/5} is picked to minimize the integral mean-square error (where ç is the sample variance and S is the sample size). For the M-L mixture, we used M′=300 location parameters with scale parameters in the set σₘ∈{1, 2, 3, 4, 5} (i.e., M=1500 mixture components were used in the estimation procedure).

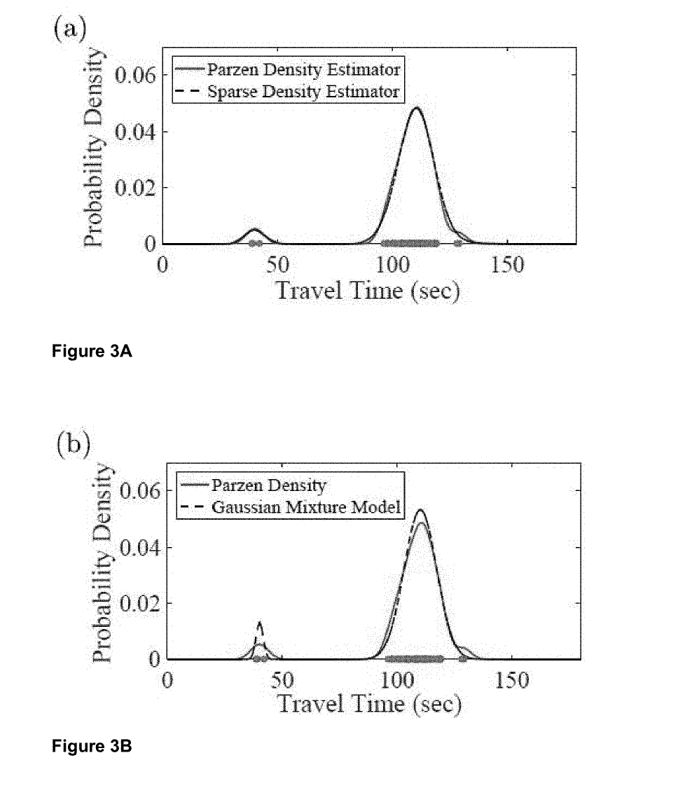

FIG. 3 (a) shows the PW PDF and the estimated sparse PDF (using M-L functions) for the travel times of the southbound vehicles during the noon period. The fitted distribution is clearly bi-modal and closely follows the PW PDF. The bi-modality of the travel time distribution can be attributed to the presence of two traffic states: non-stopped vehicles along the entire corridor in the southbound direction and stopped vehicles experiencing delay at one or more of the signals. Observe that while the number of mixture components required to calculate the PW density is equal to the number of data samples (58 for this case), the proposed estimation algorithm achieves a similar accuracy with a much sparser representation: only four M-L mixture components were needed; i.e., a compression rate of about 15:1.

We compared our approach against the Expectation Maximization (EM) algorithm (Bishop, 2006), the prevalent method for estimation of Gaussian mixture models (Wan et al., 2014). The EM algorithm (using Gaussian mixtures) has been widely used for the estimation of travel time densities, despite its slow rate of convergence (Wu, 1983; Archambeau et al., 2003), and the dependence of the parameter estimates on the choice of the initial values (Biernacki et al., 2003). The commonly adopted method to prevent the EM algorithm from getting trapped in local minima is to start the algorithm with different initial random guesses (Wan et al., 2014). The importance of properly defining the stopping criterion to ensure that the parameters converge to the global maximum of the likelihood function has been highlighted in (Karlis and Xekalaki, 2003; Abbi et al., 2008). In all our experiments, we used ten randomly selected initial estimates; for termination criterion, we used tolerance threshold (selected as 10⁻³) on the absolute difference between two successive root-mean squared error (RMSE) estimates, where

$$RMSE = \sqrt{\frac{1}{N} {\sum }_{j = 1}^{N} {( \hat{p} ( {t}_{j} ) - \overline{p} ( {t}_{j} ) )}^{2}} .$$

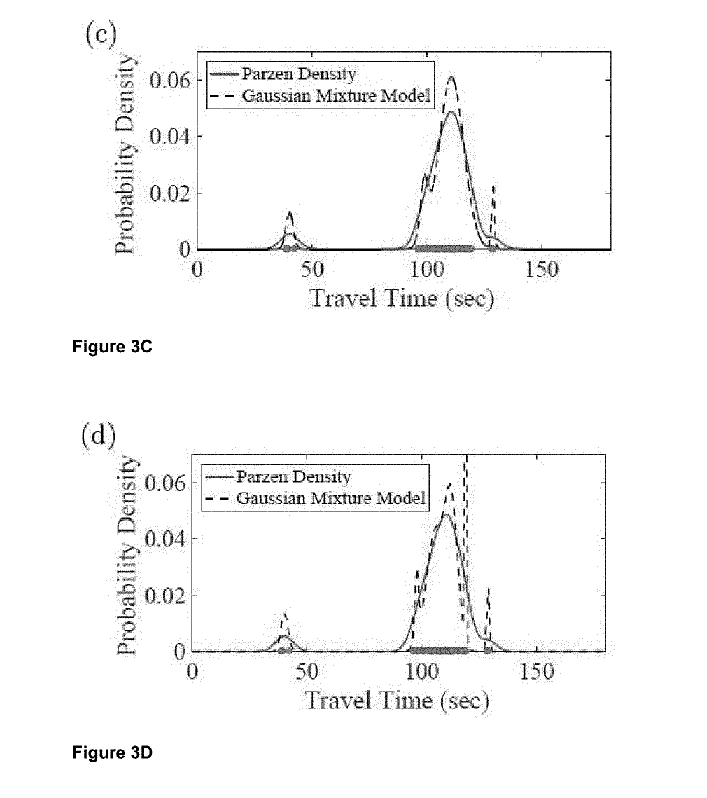

A known issue with the EM algorithm is that it requires predetermining the number of mixture components. This is in contrast to our method, which optimally determines the number of mixture components concurrently with the fitting procedure. Given the number of mixture components, the EM algorithm is an iterative method used to estimate the mean and variance of each Gaussian mixture density, along with the weight vector θ. Note that the EM algorithm solves for maximum-likelihood estimates of the mixture distribution parameters; it does not minimize the RAISE. FIG. 3 and Table 2 summarize the results. The optimal sparse fitting contains four M-L mixture components and we also tested the EM algorithm with two, four and six Gaussian mixture components. Increasing the number of components in the EM algorithm increases (i.e., improves) the log-likelihood but the RMSE tends to get worse beyond two mixture components. This is indicative of the EM algorithm's tendency to over-fit to artifacts in the data with larger numbers of mixture components. This is indicative of a susceptibility to data errors of the EM algorithm. In contrast, our model has the favorable property that the goodness-of-fit typically increases with the number of mixture components used. FIG. 4 illustrates this using travel times from another dataset (namely, I-80): we evaluated the RMSE for our sparse density estimator vs. the EM algorithm with varying numbers of mixture components (for M-L component densities, we varied the regularizing parameter w so as to achieve different sparsity levels).

TABLE 2
Performance comparison: M-L vs. EM.

| | Number of mixture | | |
|---|---|---|---|
| Method | components | RMSE | Log-likelihood |
| Sparse M-L | 4 | 0.0004 | N/A |
| Estimator | | | |
| EM | 2 | 0.0009 | 0.0021 |
| EM | 4 | 0.0012 | 0.0029 |
| EM | 6 | 0.0063 | 0.0152 |

7.3. Inference with Parsimonious Models

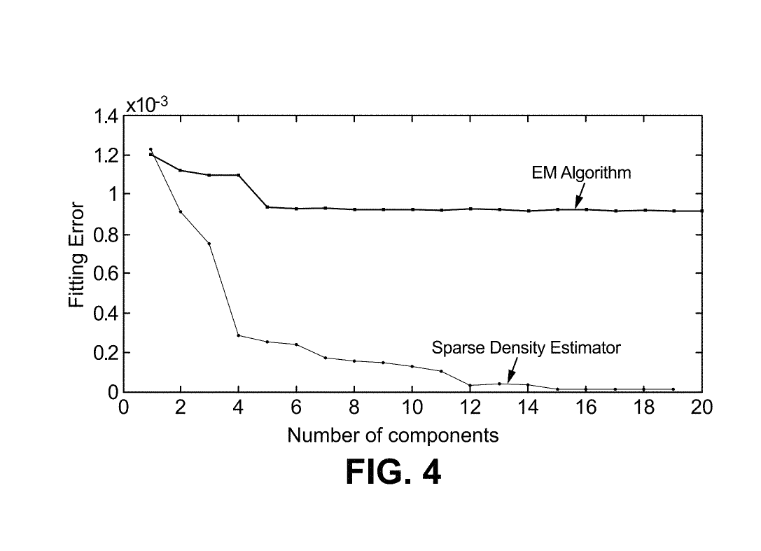

In order to highlight the predictive capabilities and interpretability of parsimonious models, we have tested our method on hold-out real data from the I-80 dataset: We divided the bulk of the I-80 data in two parts (corresponding to different timestamps): (i) a training dataset and (ii) a hold-out test dataset (where we selected a ratio of 4:1 for training vs. test data). We then fit our model using the training data and tested its performance (measured via goodness-of-fit) on the hold-out test data. It is worth noting that this scenario is a challenging one due to the heterogeneity of the travel times recorded over intervals of variable traffic conditions. The results are reported in FIG. 5: FIG. 5 (a) plots the PW on the training and hold-out data, along with the sparse density obtained using M-L mixture densities (12 mixture components were used by our sparse density estimator in this case); FIG. 5 (b) plots the fitting error (RMSE) for both our method and the EM algorithm using a varying number of mixture components, namely 1-12. It is evident from this experiment that our method clearly outperformed the EM algorithm in terms of higher fitting accuracy on hold-out data.

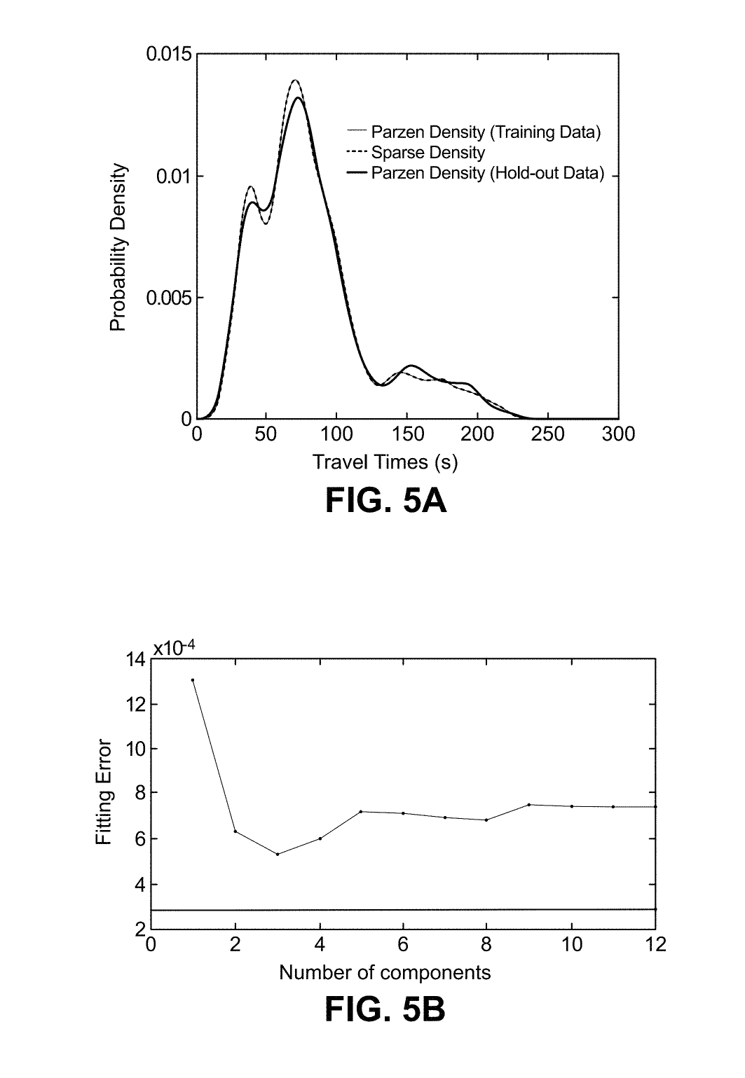

We tested our method vs. l₂-regularization on the Peachtree (northbound, noon) dataset. For both methods, we chose M=1500 M-L mixture components for model selection (M′=300 and a scale parameter set σₘ∈{0.2, 0.3, 0.5, 1, 1.5}). For l₂-regularization, the value \tilde{w} was selected from the set {5·10⁻⁵, 5·10⁻⁴, 5·10⁻³, 5·10⁻², 5·10⁻¹} by 5:1 cross-validation. FIG. 6 illustrates the results.

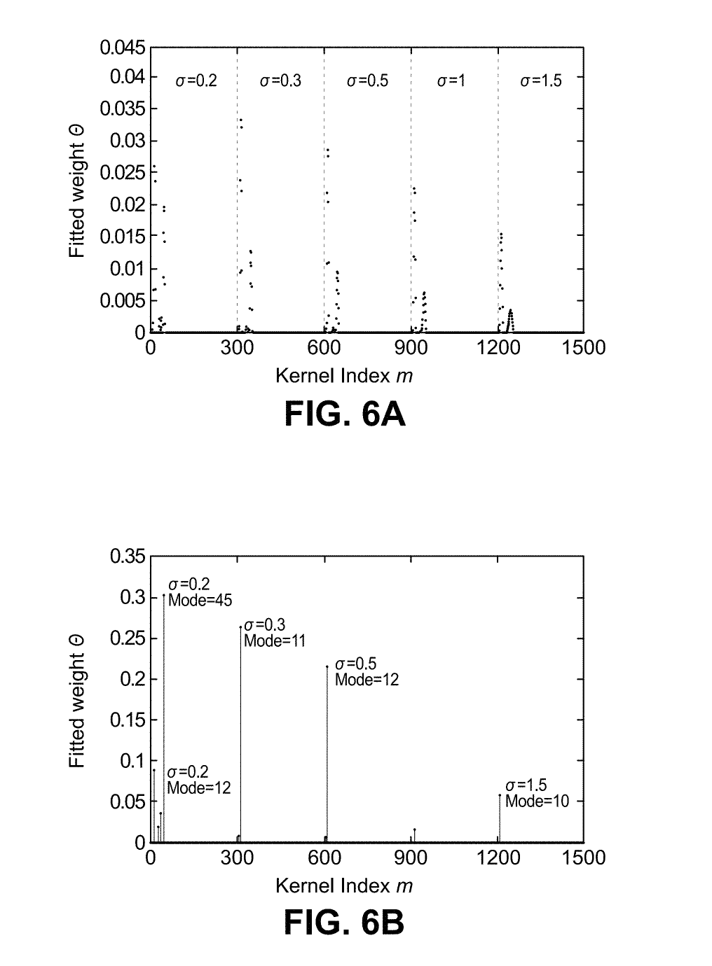

Both methods achieved an RMSE of about 0.008. Nonetheless, the number of mixture components (and corresponding weights) that need to be stored to re-create and predict the travel time distribution was substantially reduced to only 5 M-L mixture densities using sparse density estimation (from 84 needed for l₂-regularization). In addition to reduced storage requirements, the sparse density estimate allows for making inference with ease about the underlying data through the selected mixture components and their corresponding weights. For instance, the selected M-L components indicate that the underlying travel time data can be approximated well by two peaks located at around t=11 and t=45. On the other hand, the mixture components selected by the l₂-norm regularization are much less informative. This parsimony is further illustrated in FIG. 7 where the experiment was conducted on the I-80 dataset.

7.4. Merits of Mittag-Leffler Mixture Densities

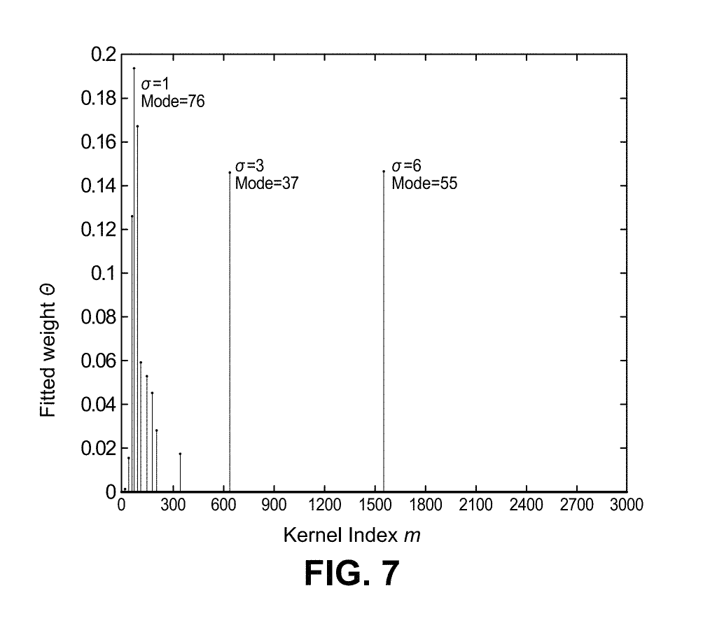

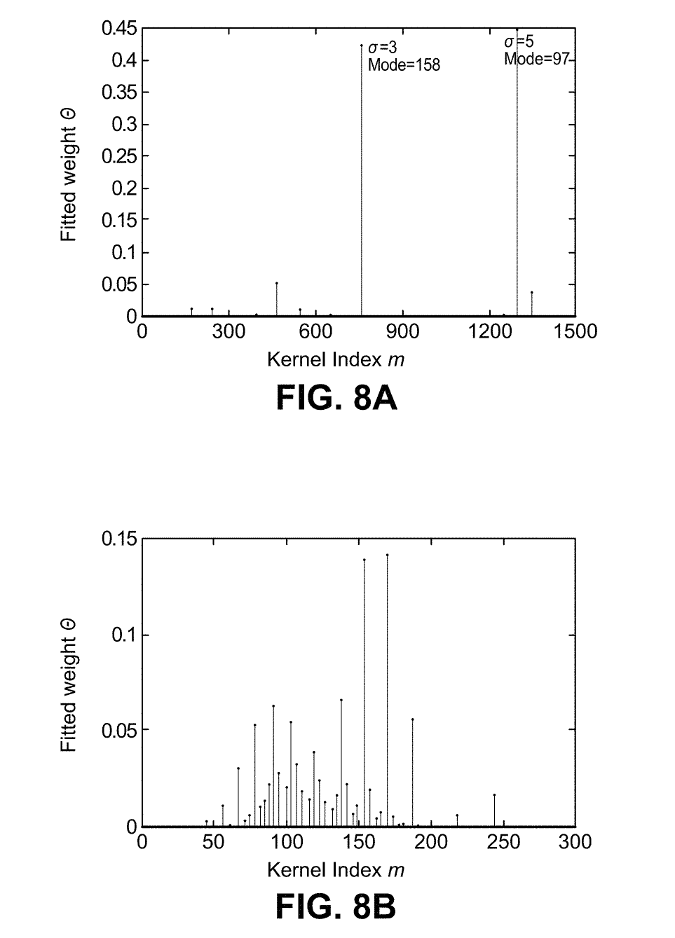

In this section, we demonstrate the superiority of the adaptive approach with M-L mixture densities over the non-adaptive (Gamma mixture densities with a single-scale parameter s) in terms of parsimony. For this case study, we considered the travel time distribution of the northbound traffic along Peachtree street in the noon time period. The sparse density estimation was first carried out using the M-L mixture densities with σₘ∈{1, 2, 3, 4, 5} and then using Gamma mixture densities with single parameter σ=1. The solutions are depicted in FIG. 8(a) and FIG. 8(b) respectively, where we have used M=1500 (M′=300 uniform per-second discretization) for the M-L mixture densities and M=300 for the Gamma mixture densities. The figures indicate that the travel time density can be efficiently represented using two dominant modes (with different scale parameters). However, in the case of the Gamma mixture, a much larger number of components was required. Although using a σ=5 reduces the number of Gamma mixture components required to 2, the sparse Gamma estimate cannot accurately capture the shape of the distribution, as shown in FIG. 9(a); in contrast, the estimated M-L mixture is indistinguishable from the PW density, as depicted in FIG. 9(b).

Interpreting the Results.

From the weight vector of the M-L mixture in FIG. 8(a), it is clear that the predominant mixture components associated with the highest weights are the M-L densities with σ=5 located at t=97 seconds, and σ=3 located at t=158. From this alone, we can infer the most likely travel times of the northbound (noon) traffic along Peachtree street, whereas the weight vector associated with the Gamma mixture is not quite as informative.

7.5. Real-World Testing of Recursive Algorithm

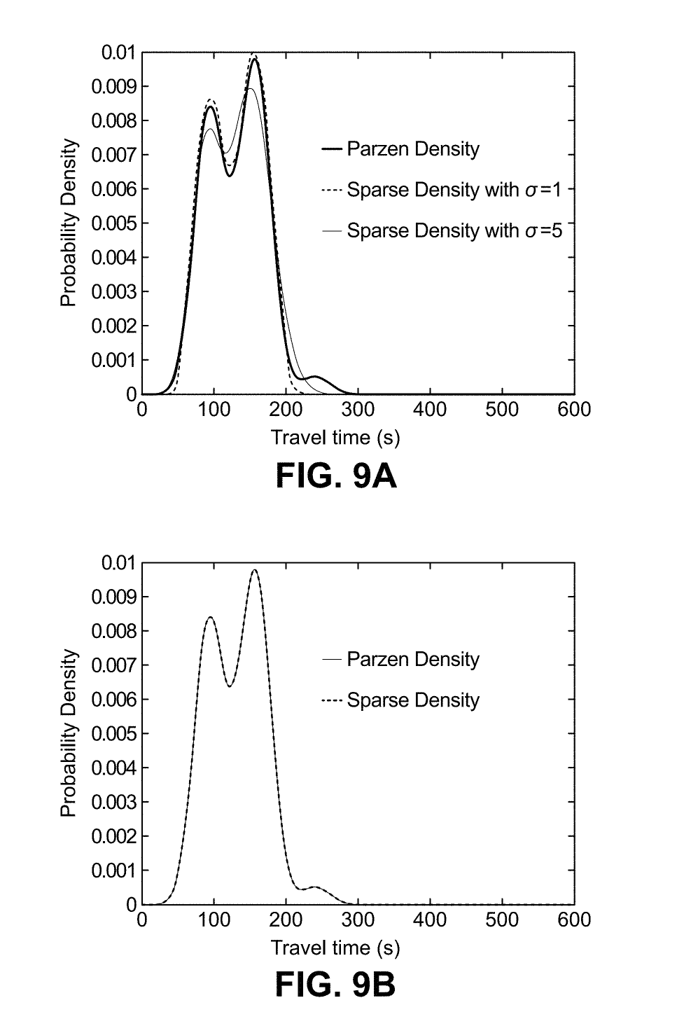

The recursive algorithm on streaming data was tested using the I-80 dataset. We track the changes in the travel time density on I-80 using the recursive algorithm, by taking a fixed window size of W=100 travel time samples for each instance of sparse density estimation (along with parameters M′=300, N=600 corresponding to per-second uniform discretization and scale parameters σₘ∈{1, 2, 3, 4, 5}, whence M=1500 M-L mixture components are considered). By processing the newly arriving samples one at a time (and simultaneously discarding the oldest ones), the density is constantly updated with time following the mechanism presented in Subsection 7.2. The travel time densities for the PM peak period predicted by the recursive algorithm are depicted in FIG. 10, where we can observe that the number of modes, as well as their locations, vary significantly over time.

For the first time period under consideration, the travel time density at (a representative) time of 4:04 p.m. is plotted; clearly, the density can be captured by a bi-modal distribution. This corresponds to the uncongested period where the travel times of nearly all the vehicles are below 80 seconds. However, at about 5:08 p.m. (which represents the time when congestion begins to build up), the number of modes increases to 3, introducing a new cluster of vehicles with travel times between 70 and 120 seconds. After congestion has set in, the number of modes again reduces to 2 in the third time-period, and the locations of these modes indicate that the travel times of all vehicles have increased. In brief, these results highlight the capability of the recursive algorithm to track the varying travel time density in real-time, in a means that is also robust to the variations encountered by individual vehicles. The model parameters estimated by the recursive algorithm reflect the underlying traffic conditions, and can capture the multi-modality in these distributions very efficiently.

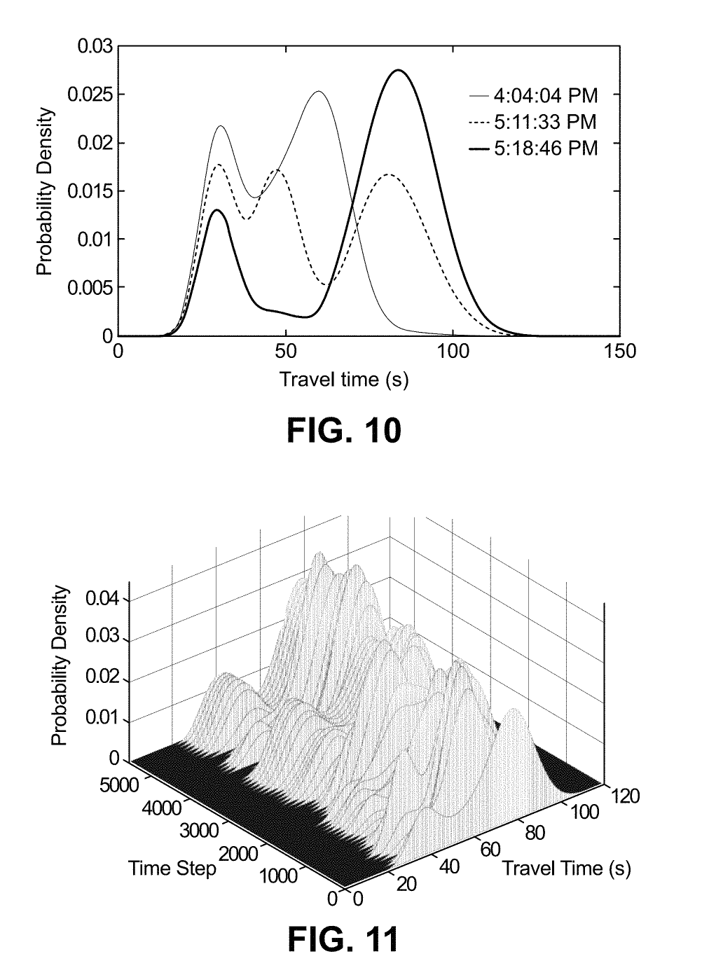

The run-time was reported to be just over 2.5 minutes for recursive estimation vs. about 2.5 hours using the standard method (non-recursive one). This experiment solidifies our claim for the feasibility of a truly real-time implementation of our methods (note that a run-time of 2.5 minutes was needed to track the variability over an interval of 45 minutes). A series of snapshots illustrating the dynamic variation of densities is given in FIG. 11.

In this sparsity-seeking framework, ensuring integrability of the kernel estimates (i.e., ensuring that the resulting function is a PDF) cannot be achieved by normalization as is traditionally done. For this purpose, we developed a new kernel using Mittag-Leffler functions, which were shown to outperform Gaussian kernels (in terms of sparsity).

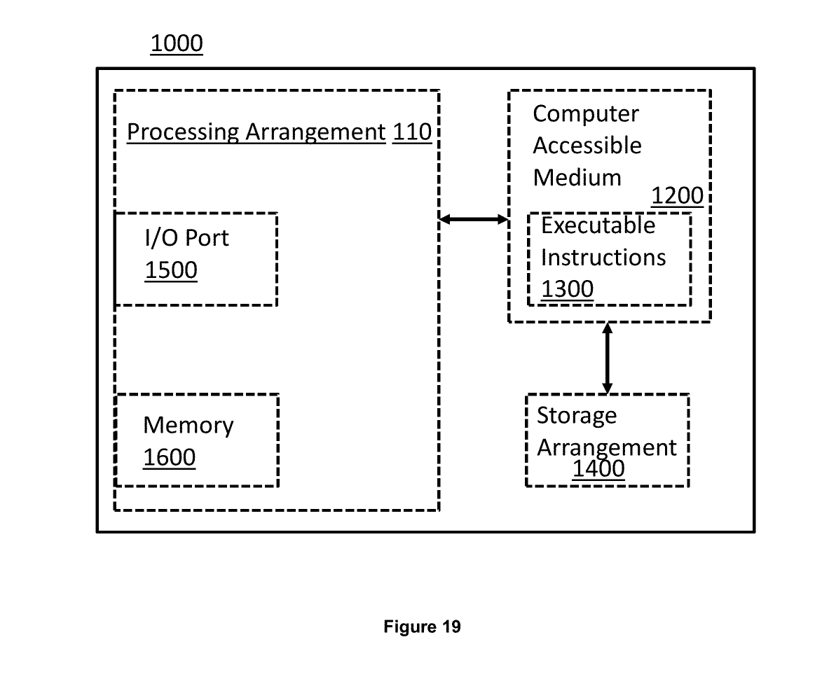

As shown in FIG. 19, e.g., a computer-accessible medium 1200 (e.g., as described herein, a storage device such as a hard disk, floppy disk, memory stick, CD-ROM, RAM, ROM, etc., or a collection thereof) can be provided (e.g., in communication with the processing arrangement 1100). The computer-accessible medium 1200 may be a non-transitory computer-accessible medium. The computer-accessible medium 1200 can contain executable instructions 1300 thereon. In addition or alternatively, a storage arrangement 1400 can be provided separately from the computer-accessible medium 1200, which can provide the instructions to the processing arrangement 1100 so as to configure the processing arrangement to execute certain exemplary procedures, processes and methods, as described herein, for example. The instructions may include a plurality of sets of instructions. For example, in some implementations, the instructions may include instructions for applying radio frequency energy in a plurality of sequence blocks to a volume, where each of the sequence blocks includes at least a first stage. The instructions may further include instructions for repeating the first stage successively until magnetization at a beginning of each of the sequence blocks is stable, instructions for concatenating a plurality of imaging segments, which correspond to the plurality of sequence blocks, into a single continuous imaging segment, and instructions for encoding at least one relaxation parameter into the single continuous imaging segment.

System 1000 may also include a display or output device, an input device such as a key-board, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

As used herein, the singular forms “a”, “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A computer-implemented machine for travel time density estimating comprising:
a processor; and
a tangible computer-readable medium operatively connected to the processor and including computer code configured to:
discretize the travel time data, wherein one kernel is associated with one travel time;
compute Parzen density; and
estimate the probability density function of travel time data with Gamma kernels using a sparse density estimation.

2. The computer implemented machine of claim 1, wherein the Parzen density is computed offline with pre-existing data.

3. The computer implemented machine of claim 2, wherein the computed Parzan density is updated with an online Parzen estimation based on real-time data, further wherein the updated Parzen density is utilized in estimating the probability density function of travel time data.

4. The computer implemented machine of claim 1, wherein the sparse kernel density estimation comprises a Mittag-Leffler kernel.

5. The computer implemented machine of claim 2, wherein a regulizer is applied to the sparse density estimation.

6. The computer implemented machine of claim 1, wherein a post-processing is applied to the sparse density estimation.

7. The computer implemented machine of claim 6, wherein the post-processing comprises a de-biasing.

8. A method for determining sparse density comprising:
choosing a level of discretization;
computing parazen density and constructing a kernel matrix;
estimating sparse density; and
applying a regularization parameter.

9. The method of claim 8, wherein the method includes an online estimation applying a stochastic differential equation.

10. The method of claim 8, further comprising selecting a regularizer.

11. The method of claim 8, further comprising receiving updated travel time data and updating the computed parzen density.

12. A non-transitory computer program product storing instructions which, when executed by at least one data processor forming part of at least one computing system, result in operations comprising
discretizing the travel time data, wherein one kernel is associated with one travel time;
computing Parzen density; and
estimating the probability density function of travel time data with Gamma kernels using a sparse density estimation.

13. The non-transitory computer program product of claim 12, wherein the Parzen density is computed offline with pre-existing data.

14. The non-transitory computer program product of claim 13, wherein the computed Parzan density is updated with an online Parzen estimation based on real-time data, further wherein the updated Parzen density is utilized in estimating the probability density function of travel time data.

15. The non-transitory computer program product of claim 12, wherein the sparse kernel density estimation comprises a Mittag-Leffler kernel.

16. The non-transitory computer program product of claim 12, further comprising applying a regulizer to the sparse density estimation.

17. The non-transitory computer program product of claim 12, wherein a post-processing is applied to the sparse density estimation.

18. The non-transitory computer program product of claim 17, wherein the post-processing comprises a de-biasing.
